(19) United States
(12) Patent Application Publication
(10) Pub. No.: US 2011/0144790 A1
(43) Pub. Date: Jun. 16, 2011

(54) Thermal Sensing for Material Processing Assemblies

(76) Inventors: Terry Gerritsen, Oakville (CA); Phillip Shadlyn, Thornhill (CA); Richard MacRosty, Burlington (CA)

(21) Appl. No.: 12/821,794

(22) Filed: Jun. 23, 2010

Related U.S. Application Data
(60) Provisional application No. 61/286,645, filed on Dec. 15, 2009.

(51) Int. Cl. G06F 19/00; G01K 11/32

(52) U.S. Cl. 700/108; 374/161; 374/E11.015

(57) ABSTRACT

Various embodiments of thermal sensing systems and methods for monitoring thermal conditions in such material processing assemblies are described. The thermal sensing systems include a sensor cable that incorporates or is coupled to one or more thermal sensors. The sensor cable is positioned in the assembly and the thermal sensors provide temperature measurements. In various embodiments, the sensor cable and thermal sensors may be optical or electrical devices.

### CROSS REFERENCES TO RELATED APPLICATIONS

This application claims priority from U.S. Provisional Patent Application No. 61/286,645, filed on Dec. 15, 2009, which is incorporated herein by reference in its entirety.

### FIELD

The described embodiments relate to material processing assemblies, such as metal or glass processing assemblies, and more particularly to temperature sensing elements for material processing assemblies.

### BACKGROUND

Material processing assemblies may be used to process various materials, such as glass, metals, or ceramics. Material processing assemblies may include, for example, elevated temperature reactors such as furnaces, or forming assemblies such as continuous casting assemblies.

Elevated temperature reactors are used to process materials using heat. Elevated temperature reactors include various types of metallurgical reactors, including metallurgical furnaces, autoclaves, hot gas vessels (such as flash furnaces, combustion chambers, or gas-solids reactors), electric arc furnaces, induction furnaces, blast furnaces, slag furnaces and aluminum electrolytic cells. Other types of elevated temperature reactors include gasification reactors, ceramic vent diffusers, and glass furnaces. Elevated temperature reactors may operate at a temperature of a few tens of degrees Celsius above standard temperature (20° C.), or they may operate at very high temperatures of thousands of degrees Celsius above standard temperature.

Various types of elevated temperature reactors are used for different types of material processing. For example, pyrometallurgical furnaces are used to process metal ore, scrap metal feedstock or other impure metal sources (which may generally be referred to as “feedstock”) to separate metal from waste components in the feedstock. The feedstock is melted in the furnace. When heated to a sufficient temperature, molten slag separates from the molten metal and typically floats above the metal. The molten metal and slag are removed from the furnace through one or more tapholes provided in the furnace wall.

Due to the high temperatures within pyrometallurgical furnaces and some other elevated temperature reactors such as induction furnaces, refractory linings, and other thermal protective elements, are used to protect the furnace wall and other components of the furnace from the molten metal and slag, hot process gas (in furnace freeboard, for example), or other high temperature contents of the furnace. In addition, some components of the furnace may be cooled with a liquid or gas cooling system. Tapblocks are commonly made of a metal such as copper. A tapblock is installed in the wall of the furnace and has a tapping channel extending from the interior of the furnace to the exterior of the furnace, allowing molten metal and slag to be withdrawn from the furnace. The tapping channel is also lined with refractory, which is typically continuous with the refractory lining of the interior wall of the furnace. The tapping channel is plugged with clay when feedstock is being melted in the furnace. When molten metal or slag is ready to be removed from the furnace, the tapping channel is opened by lancing or other methods. Following the removal of molten metal or molten slag from the furnace, the tapping channel is again sealed with clay. Over time, the refractories in the tapblock channel and at the hot face of the furnace wall wear down due to thermal and mechanical stresses. In particular, the refractory in and near the tapblock is subject to significant stresses due to repeated tapping operations. If the refractory wears sufficiently, the molten metal or slag may come into contact with components of the furnace, the tapblock, or the cooling system, causing damage to the furnace. In severe cases, the furnace may explode causing damage to nearby property and putting plant personnel at risk. It is essential to monitor the state of the refractory to ensure that it has sufficient thickness to protect the furnace and its surroundings.

Various methods have been developed to monitor the state of the refractory, including various thermal sensing devices. For example, thermocouples, resistive temperature devices and other sensing elements may be installed in the tapblock to monitor the refractory lining of the tapping channel and the interior of the furnace near the tapblock. Such methods are limited by restrictions on the placement of the sensing elements as well as difficulties in installing sufficient numbers of sensing elements to accurately monitor the state of the refractory.

Similar problems arise with monitoring thermal conditions in other metallurgical reactors, and in elevated temperature reactors in general. Thermal monitoring may be useful to assess the condition of protective elements such as refractory, to assess the condition of a cooling element, to monitor the operation of a cooling system, or to monitor another component or element that is subjected to elevated temperatures in a reactor.

Further, similar problems may arise in other types of material processing assemblies. For example, similar problems may arise with monitoring thermal conditions in material forming assemblies, such as continuous metal casting assemblies. Thermal monitoring may be useful to assess the condition of a cooling element such as a mould, to monitor the operation of a cooling system, or to monitor another component or element of a forming assembly that is subjected to elevated temperatures.

Accordingly, there is a need for improved thermal sensing in material processing assemblies.

### SUMMARY

The present disclosure provides new and improved systems and methods for monitoring thermal conditions in material processing assemblies, such as elevated temperature reactors, or material casting assemblies.

In some embodiments, a system for monitoring thermal conditions in a cooling element, a thermally protective element or another region or component that is subjected to elevated temperatures in a material processing assembly includes a thermal sensor mounted on a sensor cable. The sensor cable is installed in the assembly such that the sensor is positioned at a location within the assembly. A controller is coupled to the sensor cable to communicate with the sensor, including receiving signals indicating a temperature at the location of the thermal sensor.

In some embodiments, the location of the sensor may be known precisely, while in other embodiments, the sensor may be positioned generally within a region of the assembly.

In some embodiments, two or more thermal sensors are positioned along the length of the sensor cable. The controller is coupled to the sensor cable allowing the controller to communicate with each of the thermal sensors to measure the temperature at the position of each thermal sensor.

In various embodiments, the thermal sensors, sensor cable and controller are selected such that they cooperate to measure the temperature at the respective positions of the thermal sensors.

For example, in some embodiments, the sensor cable may be an optic fibre, the thermal sensors may be Bragg gratings formed in the optic fibre and the controller may be configured or programmed to identify changes in wavelengths of radiation reflected from the Bragg gratings and thereby measure the temperature within an elevated temperature reactor at the locations of the Bragg gratings.

In some embodiments, the sensor cable is also a thermal sensor. For example, the sensor cable is an optic fibre. A radiation source transmits radiation into the optic fibre. Some of the radiation is reflected due to impurities and other characteristics of the optic fibre. The controller analyzes the reflected radiation to determine a temperature at one or more positions along the length of the optic fibre. The optic fibre functions as a series of continuous thermal sensors along its length.

In some embodiments, the sensor cable is an electrical cable and the thermal sensors are thermocouples coupled to the sensor cable. The controller is coupled to the sensor cable to communicate electrically with the thermocouples.

In some embodiments, the sensor cable is an electrical cable and the thermal sensors are resistive temperature devices coupled to the sensor cable. The controller is coupled to the sensor cable to communicate electrically with the resistive temperature devices.

In other embodiments, the sensor cable may be an optic fibre while the thermal sensors are resistive thermal devices, thermocouples or other sensors that provide an electrical signal. The thermal sensors may be coupled to the optic fibre by a transducer that converts the electrical signals to optic signals suitable for transmission on optic fibre.

In various embodiments, the thermal sensors may be positioned in different parts of a material processing assembly. For example, some elevated temperature reactors contain one or more cooling elements that are used to cool other components or the contents of the elevated temperature reactor. In some embodiments, at least some of the thermal sensors may be positioned at a surface of the cooling elements adjacent to another element of the elevated temperature reactor, such as a refractory lining that protects structural components of the elevated temperature reactor from heated contents of the elevated temperature reactor. The thermal sensors placed adjacent to the other elements can be used to monitor the condition of the element.

Elevated temperature reactors may have various types of cooling elements. For example, reactors may have cooling blocks made of copper or other materials with a high thermal conductivity. A cooling element may absorb heat from within the reactor. The heat may be removed from the cooling element by radiation or convection into the ambient environment. In some embodiments, heat may also be removed from the reactor by a liquid or gas cooling system provided in or with the cooling element. Some components of a reactor may serve multiple purposes, including cooling of the reactor. For example, some reactors have a metal outer shell, which provides structural support for the reactor and also acts as a cooling element. The metal shell absorbs heat from the contents of the reactor. This heat is released into the ambient environment through radiation and convection, thereby cooling the reactor. In some embodiments, the shell may be cooled with a forced air or other cooling system. In some embodiments, the shell may include an embedded or surface mounted gas or liquid cooling system. In general, any element that absorbs heat from the contents of the reactor or another component of the reactor and removes the heat from the reactor either passively (by radiation or convection) or actively (through a liquid or gas cooling system) is a cooling element.

In other embodiments with a cooling element, at least some of the thermal sensors may be positioned within the cooling element. A thermal sensor may also be mounted adjacent to the cooling element to monitor the cooling element or adjacent components of the material processing assembly.

In embodiments having a cooling element that includes a gas or liquid cooling system, the thermal sensors may be positioned adjacent to components of the cooling system.

In some embodiments, the sensor cable and thermal sensors may be encased within a conduit such as a metal pipe. The conduit may serve as a protective sheath for the sensor cable. The conduit may also facilitate installation of the sensor cable and thermal sensors within the elevated temperature reactor.

In one aspect, the present disclosure provides a system for sensing thermal conditions in an elevated temperature reactor, the system comprising: a cooling element mounted within the reactor; a sensor cable mounted to the cooling element; two or more thermal sensors positioned along the length of the sensor cable; and a controller coupled to the sensor cable to receive information from the thermal sensors.

In some embodiments, the sensor cable is mounted to the cooling element in a path, and the thermal sensors are positioned along the path at selected locations.

In some embodiments, the thermal sensors are resistive temperature devices and the sensor cable electrically couples the thermal sensors to the controller to allow the controller to communicate with the sensors.

In some embodiments, the thermal sensors are thermocouples and the sensor cable electrically couples the thermal sensors to the controller to allow the controller to communicate with the sensors.

In some embodiments, the sensor cable is an optic fibre and the thermal sensors are Bragg gratings formed in the optic fibre.

In some embodiments, the sensor cable is an optic fibre and the thermal sensors provide electrical signals, and each thermal sensor is coupled to the sensor cable through a transducer.

In some embodiments, the reactor is a metallurgical reactor, and at least some of the thermal sensors are positioned to monitor components of the reactor adjacent to the cooling element.

In some embodiments, the cooling element is a tapblock.

In some embodiments, the reactor is a metallurgical reactor having a tapblock, and at least some of the thermal sensors are positioned to monitor the tapblock.

In some embodiments, the reactor is an aluminium electrolytic cell and at least some of the thermal sensors are positioned to monitor components of the aluminum electrolytic cell.

In some embodiments, the reactor comprises a side plate and at least some of the thermal sensors are positioned to monitor the temperature of the side plate.

In some embodiments, the reactor is a glass reactor and at least some of the thermal sensors are positioned to monitor components of the reactor adjacent to the cooling element.

In some embodiments, the reactor is an induction furnace, and at least some of the thermal sensors are positioned to monitor components of the reactor adjacent to the cooling element.

In some embodiments, the reactor is a combustion chamber comprising an off-gas chimney, and at least some of the thermal sensors are positioned to monitor the temperature of the off-gas chimney.

In another aspect, the present disclosure provides a system for sensing thermal conditions in an elevated temperature reactor, the system comprising: a thermally protective element; a sensor cable; two or more thermal sensors positioned along the length of the sensor cable and positioned to monitor the thermally protective element; and a controller coupled to the sensor cable to receive information from the thermal sensors.

In some embodiments, the reactor has a cooling element and at least some of the thermal sensors are positioned to monitor thermal conditions adjacent to the cooling element.

In some embodiments, the reactor has a cooling element and at least some of the thermal sensors are positioned to monitor thermal conditions within the cooling element.

In some embodiments, at least some of the thermal sensors are mounted within the thermally protective element.

In some embodiments, at least some of the thermal sensors are mounted adjacent to the thermally protective element.

In some embodiments, the thermally protective element is a refractory lining.

In some embodiments, the reactor is a metallurgical reactor having a tapblock and at least some of the thermal sensors are positioned to monitor components of the reactor adjacent to the tapblock.

In some embodiments, the reactor is a metallurgical reactor having a tapblock and at least some of the thermal sensors are positioned to monitor the tapblock.

In some embodiments, the reactor is a glass reactor having a cooling element and at least some of the thermal sensors are positioned to monitor components of the reactor adjacent to the cooling element

In some embodiments, the reactor is a glass reactor having a cooling element and at least some of the thermal sensors are positioned to monitor the cooling element.

In some embodiments, the reactor is an induction furnace having a cooling element, and at least some of the thermal sensors are positioned to monitor components of the reactor adjacent to the cooling element.

In another aspect, the disclosure provides a system for sensing thermal conditions in an elevated temperature reactor, the system comprising: an optic fibre having a first end and a second end; a radiation source coupled to the first end of the optic fibre for transmitting radiation into the optic fibre; a radiation sensor for sensing radiation reflected from within the optic fibre; a controller coupled to the radiation sensor to sense radiation reflected from within the optic fibre and configured to measure a temperature at a position within the reactor based on the sensed radiation.

In some embodiments, the system includes a tapblock, and the optic fibre is mounted to the tapblock.

In some embodiments, the system includes a conduit mounted to the tapblock, the optic fibre is positioned within the conduit, and the second end of the optic fibre is able to slide within the conduit.

In some embodiments, the optic fibre includes one or more Bragg gratings, the radiation sensor is configured to detect a Bragg wavelength of radiation reflected from one of the Bragg gratings, and the controller is configured to measure the temperature in the reactor in the region where the Bragg grating is located.

In some embodiments, the optic fibre includes a plurality of Bragg gratings spaced along the length of the optic fibre, each of the Bragg gratings is tuned to reflect a different range of wavelengths in response to different temperature conditions, and the controller is configured to measure the temperature at the position of a particular Bragg grating by controlling the radiation source to transmit radiation corresponding the particular Bragg grating and in response to a Bragg wavelength sensed by the radiation sensor.

In some embodiments, the system further includes an output device coupled to the controller to present the measured temperature to an operator.

In some embodiments, the optic fiber comprises a strain relief unit.

In another aspect, a metallurgical furnace according to the disclosure comprises a shell having a side plate; a tapblock mounted in the side plate, the tapblock having a cold face, a hot face and a tapping channel; a wall refractory lining an interior side of the side plate adjacent the hot face; an optic fibre mounted to the metallurgical furnace; a radiation source for transmitting radiation into the optic fibre; a radiation sensor for sensing radiation reflected from within the optic fibre; and a controller coupled to the radiation sensor for estimating a temperature in at least one position of the metallurgical furnace based on radiation sensed by the radiation sensor.

In some embodiments, the optical fibre includes at least one Bragg grating and the optic sensor is adapted to sense a Bragg wavelength of radiation reflected by one of the Bragg gratings.

In some embodiments, the Bragg grating is positioned in a location selected from the group consisting of: between the hot face and the wall refractory; within the wall refractory; and within the tapblock adjacent the hot face.

In some embodiments, the furnace includes tapping channel refractory lining the tapping channel, and the Bragg grating is positioned in a location selected from the group consisting of: within the tapping channel refractory; between a surface of the tapblock and the tapping channel refractory; and within the tapblock adjacent the tapping channel refractory.

In some embodiments, the furnace includes a cooling system for cooling the tapblock, the cooling system includes one or more cooling pipes embedded within the tapblock, and the Bragg grating is positioned in a location selected from the group consisting of: adjacent one of the cooling pipes; within one of the cooling pipes; within the tapblock with a cooling pipe positioned generally between the Bragg grating and the tapping channel; and within the tapblock with a cooling pipe positioned generally between the Bragg grating and the hot face.

In some embodiments, the optic fibre is mounted within a conduit.

In some embodiments, the furnace includes an output device coupled to the controller to present a temperature reading based on the sensed wavelength.

In another aspect, the disclosure provides a method of sensing thermal conditions in a metallurgical furnace, the method comprising: providing a tapblock in a wall of the metallurgical furnace; installing an optic fibre at least partially within the metallurgical furnace; transmitting radiation into the optic fibre; sensing a reflected signal from the optic fibre; and measuring the temperature at a location along the length of the optic fibre based on the reflected signal.

In some embodiments, installing the optic fibre includes: installing a conduit on the tapblock to contain the optic fibre; and installing the optic fibre within the conduit.

In some embodiments, installing the optic fibre includes, first installing the optic fibre onto the tapblock, and then installing the tapblock in the wall of the metallurgical furnace.

In some embodiments, installing the optic fibre includes: installing a leader within a conduit; installing the conduit on the tapblock; and installing the optic fibre within the conduit by: coupling the optic fibre to the leader; and pulling the optic fibre into the conduit.

Some embodiments include, after installing the leader with the conduit, bending the conduit to a shape suitable for installation on the tapblock.

In some embodiments, the optic fibre includes a plurality of Bragg gratings spaced along the length of the optic fibre, transmitting radiation into the optic fibre includes transmitting radiation having a range of wavelengths corresponding to a particular Bragg grating, and sensing a reflected signal includes identifying a Bragg wavelength of the reflected radiation.

In some embodiments, the method includes presenting the measured temperature.

In some embodiments, the method includes presenting the measured temperature together with the location of the particular Bragg grating.

Another aspect of the disclosure provides a method of sensing temperatures at a plurality of locations in an elevated temperature reactor, the method comprising: installing an optic fibre in the reactor, wherein the optic fibre includes a plurality of Bragg gratings; selecting a particular Bragg grating at one of the locations; transmitting radiation into the optic fibre at a range of wavelengths corresponding to the selected Bragg grating; sensing radiation reflected by the selected Bragg grating; determining a temperature based on the wavelength of the sensed radiation; and repeating the steps of selecting a Bragg grating, transmitting radiation, sensing reflected radiation and determining a temperature for each of the locations.

In some embodiments, installing the optic fibre includes positioning at least one of the Bragg gratings in a selected position in the reactor.

In some embodiments, the method includes selecting the optic fibre such that the Bragg gratings are spaced such that when the optic fibre is installed in the reactor, at least one of the Bragg gratings is positioned in a selected position.

In some embodiments, installing the optic fibre includes positioning a plurality of the Bragg gratings in selected positions in the reactor.

In some embodiments, the reactor includes a tapblock having a hot face and wall refractory, and installing the optic fibre includes positioning at least one of the Bragg gratings in a location selected from the group consisting of: between the hot face and the wall refractory; within the wall refractory; and within the tapblock adjacent the hot face.

In some embodiments, the reactor includes a tapblock having a tapping channel that is lined with tapping channel refractory, and installing the optic fibre includes positioning at least one of the Bragg gratings in a location selected from the group consisting of: within the tapping channel refractory; between a surface of the tapblock and the tapping channel refractory; and within the tapblock adjacent the tapping channel refractory.

In some embodiments, the reactor includes a tapblock having a cooling system embedded within the tapblock, the cooling system includes one or more cooling pipes, and installing the optic fibre includes positioning at least one of the Bragg gratings in a location selected from the group consisting of: adjacent one of the cooling pipes; within one of the cooling pipes; within the tapblock with a cooling pipe positioned generally between the Bragg grating and the tapping channel; and within the tapblock with a cooling pipe positioned generally between the Bragg grating and the hot face.

Another aspect of the disclosure provides a system for sensing thermal conditions in a material processing assembly, the system comprising: a component that is subjected to elevated temperatures; a sensor cable mounted to the component; two or more thermal sensors positioned along the length of the sensor cable; and a controller coupled to the sensor cable to receive information from the thermal sensors.

In some embodiments, the material processing assembly is an elevated temperature reactor, and the component is a cooling element of the reactor.

In some embodiments, the reactor comprises a roof and at least some of the thermal sensors are positioned to monitor the temperature of the roof.

In some embodiments, the material processing assembly is an elevated temperature reactor, and the component is a thermally protective element of the reactor.

In some embodiments, the elevated temperature reactor is a metallurgical furnace, and the component is a tapblock.

In some embodiments, the material processing assembly is a glass furnace, and the component is a cooling/heating element of the glass furnace.

In some embodiments, the material processing assembly is an induction furnace, and the component is a cooling element of the induction furnace.

In some embodiments, wherein the material processing assembly is a metal casting assembly, and the component is a mould.

In some embodiments, the component is cooling element.

In some embodiments, the component is subject to breakdown, or is adjacent to an element that is subject to breakdown.

In some embodiments, the sensor cable is mounted to the component in a path, and the thermal sensors are positioned along the path at selected locations.

In some embodiments, the thermal sensors are resistive temperature devices and the sensor cable electrically couples the thermal sensors to the controller to allow the controller to communicate with the sensors.

In some embodiments, the thermal sensors are thermocouples and the sensor cable electrically couples the thermal sensors to the controller to allow the controller to communicate with the sensors.

In some embodiments, the sensor cable is an optic fibre and the thermal sensors are Bragg gratings formed in the optic fibre.

Another aspect of the disclosure provides a system for sensing thermal conditions in a materials processing assembly, the system comprising: an optic fibre having a first end and a second end; a radiation source coupled to the first end of the optic fibre for transmitting radiation into the optic fibre; a radiation sensor for sensing radiation reflected from within the optic fibre; a controller coupled to the radiation sensor to sense radiation reflected from within the optic fibre and configured to measure a temperature at a position within the material processing assembly based on the sensed radiation.

Additional aspects of the invention are described below in the description of various example embodiments.

### BRIEF DESCRIPTION OF THE DRAWINGS

A preferred embodiment of the present invention will now be described in detail with reference to the drawings, in which:

FIG. 1 is a partial cutaway drawing of a metallurgical furnace;

FIG. 2 is a cross-sectional drawing illustrating a tapblock and other components of the metallurgical furnace of FIG. 1;

FIG. 3 is a perspective drawing illustrating the tapblock and other components of FIG. 1;

FIG. 4 illustrates a thermal sensing system of the metallurgical furnace of FIG. 1;

FIG. 5 illustrates a method for installing an optic fibre in a conduit;

FIG. 6 illustrates an optic fibre of the thermal sensing system of FIG. 4;

FIG. 7 illustrates a cooling system of the tapblock of FIGS. 2 and 3;

FIG. 8 is a partial cutaway perspective drawing illustrating various example positions in and near the tapblock of FIGS. 2 and 3 at which thermal sensors may be positioned;

FIG. 9a is a cross-sectional drawing illustrating several of the positions at which thermal sensor may be installed in a metallurgical reactor;

FIG. 9b illustrates temperatures sensed at the positions of FIG. 9a;

FIG. 10 illustrates an optic fibre installed in a refractory lining;

FIG. 11 is a partial cutaway perspective drawing of a thermal sensing system installed in a gasifier nozzle;

FIG. 12 is a perspective drawing of a thermal sensing system installed in a blast furnace stave;

FIG. 13 is a schematic illustration a continuous casting assembly;

FIG. 14 is a perspective illustration of a mould of the continuous casting assembly of FIG. 13, showing a thermal sensing system mounted to the mould;

FIG. 15a is a cross-section taken along line 15-15 in FIG. 14, showing schematically the formation of a metal shell during normal operation of the continuous casting assembly;

FIG. 15b is a cross-section taken along line 15-15 in FIG. 14, showing schematically the formation of a metal shell during abnormal operation of the continuous casting assembly;

FIG. 15c is a graph showing temperature profiles measured in the mould of FIGS. 15a and 15b;

FIG. 16 is a partial cutaway drawing of another metallurgical furnace;

FIG. 17A is a perspective drawing of another metallurgical furnace;

FIG. 17B is a an enlarged view of the region shown in circle 17B in FIG. 17A;

FIG. 17C is a cross section taken along line 17C-17C in FIG. 17B; and

FIG. 18 is a partial cutaway drawing of a flash furnace.

The drawings are for illustration only and are not drawn to scale.

### DESCRIPTION OF EXEMPLARY EMBODIMENTS

The described embodiments illustrate example systems and methods for thermal sensing systems for material processing assemblies, such as elevated temperature reactors or material forming assemblies. Various example embodiments of the invention are illustrated below in the context of various material processing assemblies. The embodiments described and illustrated have particular use in monitoring thermal conditions in various parts and components that are subjected to elevated temperatures in material processing assemblies. For example, the embodiments described and illustrated may be used in monitoring thermal conditions in various parts and components of elevated temperature reactors, including metallurgical reactors such as metallurgical furnaces, induction furnaces, flash furnaces, and aluminium electrolytic cells; glass reactors such as glass furnaces; gasification reactors; and ceramic vent diffusers. Alternately, the embodiments described and illustrated may be used in monitoring thermal conditions in various parts and components of material forming assemblies, such as metal casting assemblies. The various parts and components may include, for example, cooling elements, such as a tapblock or a mould, thermally protective elements, such as a refractory lining, or other elements such as a sidewall or chimney of an assembly.

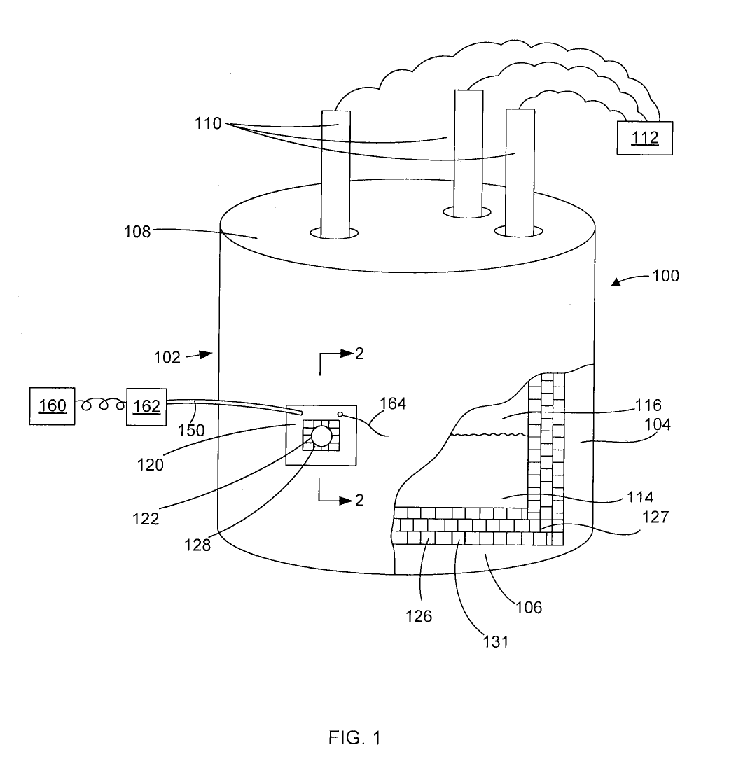

Reference is first made to FIG. 1, which illustrates a furnace 100. In the embodiment shown, furnace 100 is a metallurgical furnace. However, in alternate embodiments, furnace 100 may be an induction furnace. Metallurgical furnace 100 is a metallurgical reactor that may be used to melt metal feedstock to separate metal components from waste components and is one type of elevated temperature reactor. Furnace 100 has a metal shell 102 that includes a side plate 104 and a bottom plate 106. Furnace 100 also has a roof 108, which may be installed on the metal shell 102 to contain a melting or smelting operation within the furnace 100. In some embodiments, the roof 108 may comprise a plurality of refractory elements suspended above the metal shell 102. In other embodiments, the roof 108 may be a liquid cooled copper or steel roof, or may have another construction. In some embodiments, the roof 108 may be removable to allow the addition of feedstock to the furnace 100. In other embodiments, the roof 108 may be maintained in a fixed position and configured to allow the addition of feedstock through suitable openings. Typically, the side plate 104 and the bottom plate 106 are made of metal, such as steel. Furnace 100 also has a plurality of electrodes 110 that are extendible into the furnace 100 through openings in roof 108. The electrodes 110 are powered electrically by a power supply 112 to generate heat within the furnace 100 to melt feedstock into a molten metal phase 114 and a slag phase 116.

In other embodiments, different systems for heating the feedstock may be used. For example, instead of arc electrodes some embodiments may have an electrical induction heating system or fuel fired burners for melting the feedstock.

The side plate 104 has a tapblock 120 mounted in it. Tapblock 120 has a taphole or tapping channel 122. In this example embodiment, tapblock 120 is formed of copper. In other embodiments, a tapblock may be formed of other materials, including other metals.

The side plate 104, bottom plate 106 and tapblock 120 are lined with refractory 126. The side plate 104 is lined with wall refractory 127. The bottom plate 106 is lined with hearth refractory 131. The tapping channel 122 is lined with tapping channel refractory 128. The wall refractory 127, hearth refractory 131 and tapping channel refractory 128 are continuous with each other, providing a continuous protective barrier for the metal side plate 104, bottom plate 106 and tapblock 120.

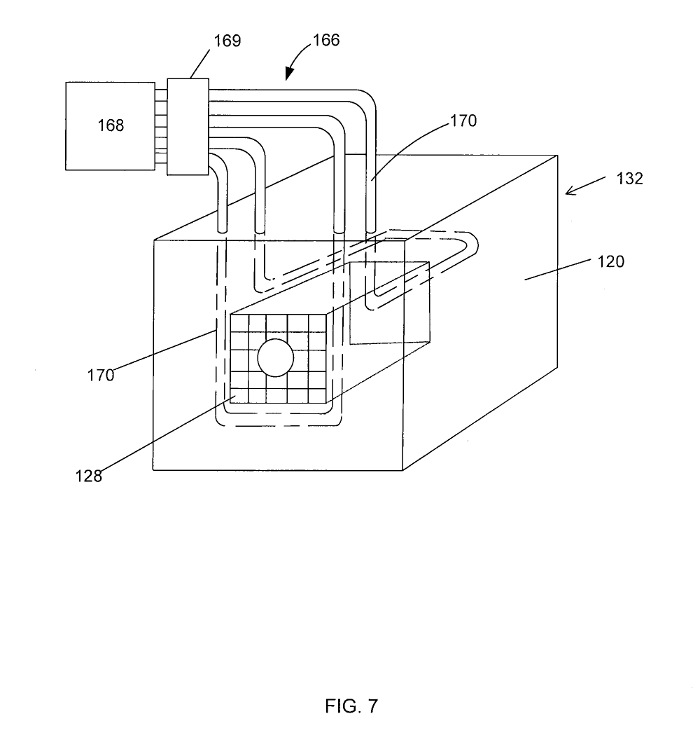

Furnace 100 has a tapblock cooling system 166 (FIG. 7) which includes a water pump 168, heat exchanger 169 and water pipes 170 embedded within the tapblock.

Tapblock 120 is an example of a cooling element in a metallurgical reactor. Tapblock 120 absorbs heat from molten materials in the furnace 100 and the tapping channel 122. Cooling system 166 removes heat from the tapblock 120. Tapblock 120 services dual purposes of both providing a tapping channel to remove molten material from the furnace 100 and also to provide cooling for the refractory 126 within and adjacent to the tapblock 120. Other types of cooling elements may be provided in metallurgical reactors. For example, a cooling element may be provided solely or primarily for the purpose of cooling part of a reactor such as the refractory lining 126, roof 108, shell 102, hearth or other components, some of which may themselves be cooling elements.

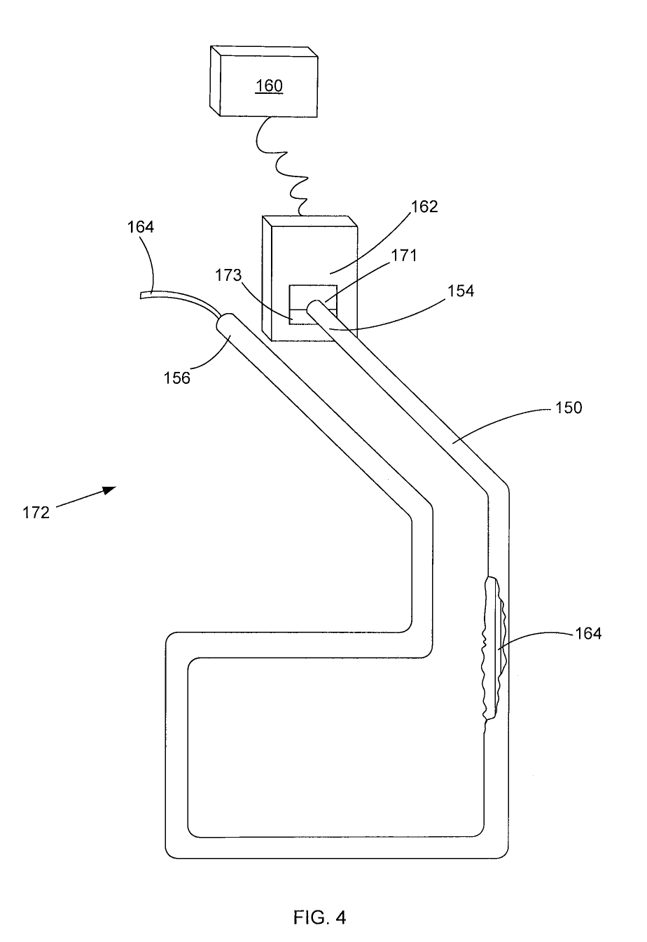

Furnace 100 also includes a thermal sensing system 172 (FIG. 4) for sensing the temperature at a number of points within the tapblock 120. Thermal sensing system 172 includes a controller 160, an optical transceiver 162, conduit 150 and an optic fibre 164.

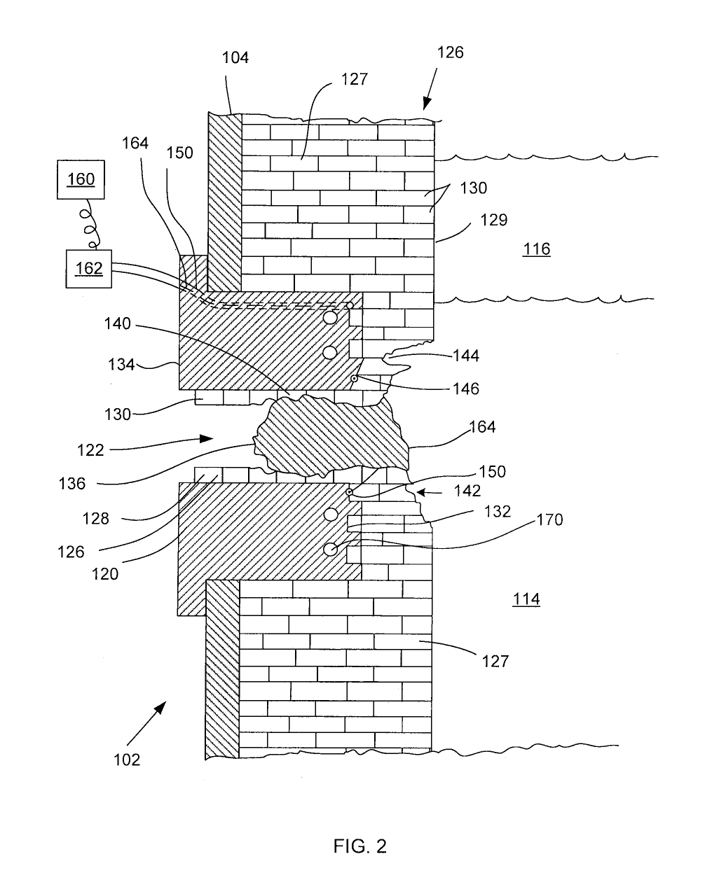

Referring to FIG. 2, tapblock 120 and the adjacent portions of furnace 100 are shown in greater detail. Wall refractory 127 on the inside of side plate 104 is formed of refractory bricks 130. A hot face 129 of the wall refractory 127 faces the inside of the furnace and the molten materials within it.

Tapblock 120 has a hot face 132 that faces the inside of the furnace 100 and a tapping side or cold face 134. Tapping channel refractory 128 is formed of refractory bricks 130. Tapping channel 122 extends from the cold face 134, past the hot face 132 of the tapblock 120 and into the interior of furnace 100. Tapping channel 122 is shown plugged with clay 136, which prevents molten metal and slag from exiting the furnace 100 through tapping channel 122 until desired. When sufficient metal or slag has been melted in furnace 100, the tapping channel 122 is opened. An operator uses a drill to break down the clay plug 136 and an oxygen lance to melt frozen metal from the tapping channel 122, allowing molten metal or slag to be extracted from the furnace 100. When sufficient molten metal 114 or slag 116 has been extracted from the furnace 100, clay 136 is injected into the tapping channel 122, stopping the flow of metal or slag.

The refractory 126 in and near the tapping channel 122 is illustrated in various stages of wear. For example, the refractory 126 may be thinned (at reference numeral 140) or cracked (at reference numeral 142). The wall refractory 127 tends to wear at its hot face 129. The refractory 126 may shift due to thermal expansion and contraction, in some cases creating cracks in the refractory 126. As the refractory 126 shifts, the refractory 126 may break down or deteriorate at gaps 144 between bricks. The refractory 126 near the tapblock 120 frequently wears more rapidly than in other areas of the furnace 100. Repetitive tapping of the tapping channel 122 causes repeated thermal and mechanical stress on the refractory 126 near the tapblock 120. The flow of molten metal and slag through the tapblock 120 causes thermal stress. Moist clay is injected into the tapping channel 122 to stop the flow of molten material from the furnace 100 at the end of the tapping process. As the moist clay hardens, it emits gases adjacent to the wall refractory 127 of the furnace causing violent stirring of the furnace contents and increasing wear of the side wall refractory 127 near the tapping channel 122. The portion of the tapblock 120 immediately above the tapping channel 122 is called the chamfer area 146. The wall refractory 127 above the tapping channel, and adjacent to the chamfer area 146 is often the most worn part of the refractory 126 due to the stirring effects of gases released from curing clay.

As the refractory 126 wears, increased heat from the molten material in the furnace 100 reaches the hot face 132 of the tapblock 120. During tapping, increased heat from molten material traveling through the tapping channel 122 reaches the metal wall of the tapping channel 122. The thickness and other conditions of the residual refractory lining 126 may be assessed by measuring the temperature at various points in the refractory 126, the tapblock 120 and other parts of the furnace 100.

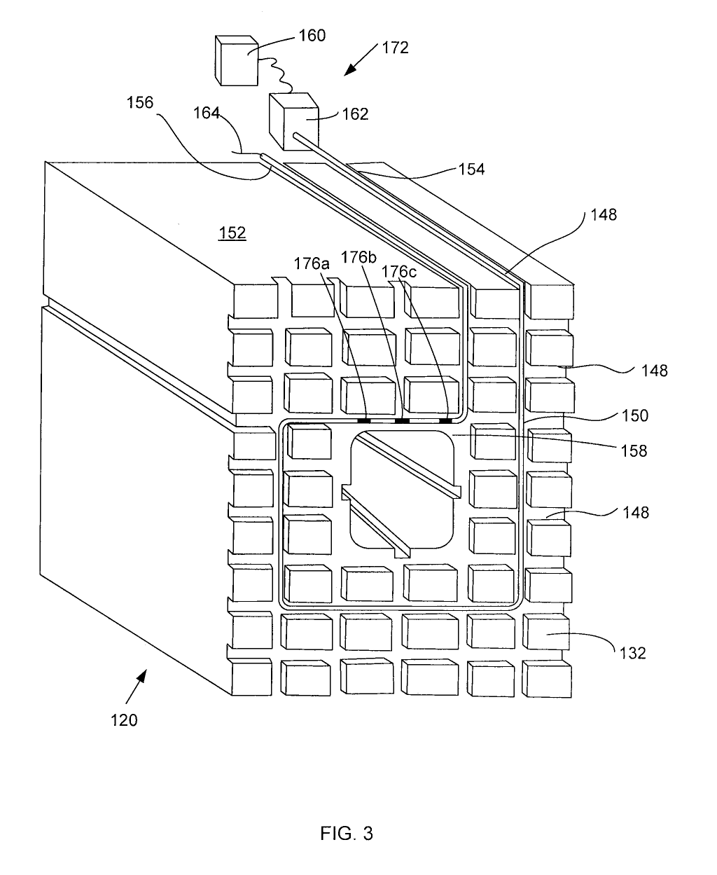

Reference is next made to FIG. 3, which illustrates tapblock 120. On its top surface 152 and hot face 132, tapblock 120 has a series of grooves 148. Conduit 150 is installed in grooves 148. Conduit 150 extends continuously from a first end 154, across the top side 152 of the tapblock 120, around the opening of the tapping channel 122 on the hot face 132, back across the top side 152 and ending at a second end 156.

Referring to FIG. 2, when tapblock 120 is installed in furnace 100, the hot face 132 is adjacent to wall refractory 127. Section 158 of conduit 150 is positioned adjacent to the chamfer area 146.

In other embodiments, the tapblock 120 may have a smooth hot face 132 or any profile on its hot face 132. Conduit 150 may be positioned adjacent to or mounted to the hot face 132.

Reference is next made to FIG. 4, which illustrates thermal sensing system 172. Controller 160 may be any form of computing device capable of controlling the operation of optical transceiver 162 and receiving information from optical transceiver 162. For example, controller 160 may be a computer, a microprocessor, a microcontroller, a special purpose integrated circuit or other device that is programmed or adapted to interface with, control and receive data from transceiver 162. Optic fibre 164 is positioned within conduit 150 and, in this embodiment, extends through the length of the conduit from the first end 154 past the second end 156. A small length of the optic fibre 164 extends out from the second end 156. The first end 154 of the conduit 150 is mounted to the transceiver 162. Transceiver 162 includes a controllable radiation transmitter or radiation source 171 that is capable of generating radiation within a frequency band and a radiation sensor 173 that is capable of detecting radiation. Optic fibre 164 is coupled to transceiver 162 at the first end 154 of the conduit 150 such that radiation source 171 can transmit radiation along the optic fibre 164 and the sensor 173 can sense radiation reflected back from the optic fibre 164.

At the second end 156, the optic fibre 164 is free to slide along the length of conduit 150. The optic fibre 164 is responsive to changes in temperature and expands and contracts lengthwise as it is heated or cooled. By leaving the end of the optic fibre 164 free to slide within the conduit 150, mechanical stresses on the optic fibre 164 due to changes in temperature are reduced.

Radiation source 171 is responsive to control signals from controller 160 to produce radiation at different wavelengths. The radiation may be in the visible light spectrum or in other spectrums capable of transmission on the optic fibre 164.

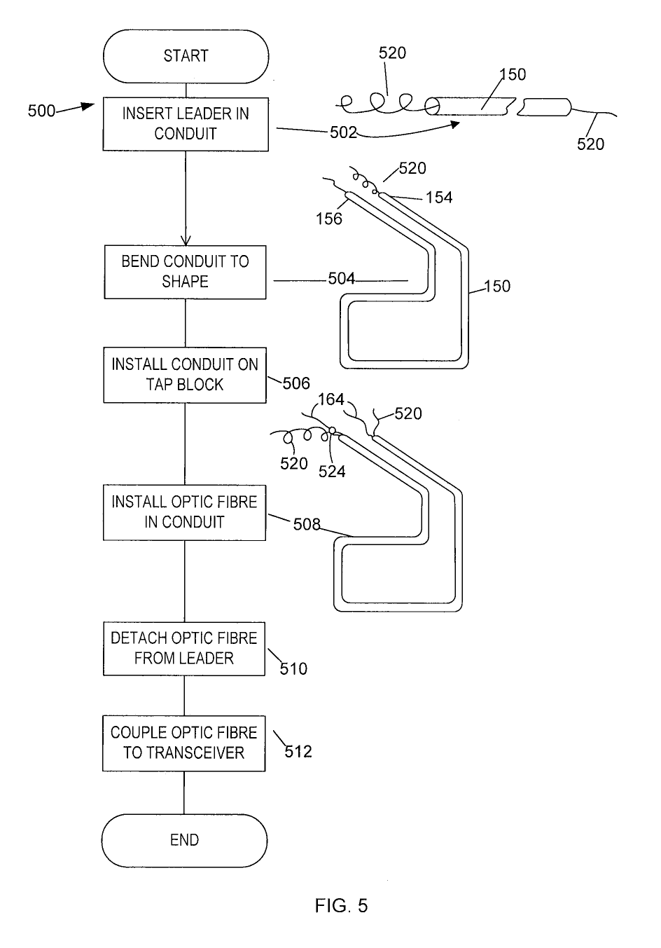

Reference is next made to FIG. 5, which illustrates a method 500 of installing the optic fibre 164 into the conduit 150.

Method 500 begins in step 502, in which a leader line 520 is installed in the conduit 150.

In the present embodiment, the conduit 150 is an austenitic nickel-chromium alloy tube. One example of a suitable austenitic nickel-chromium alloy material is Inconel™, which is available from Special Metals Corporation of New Hartford, N.Y., USA. In other embodiments, the conduit 150 may be made from another material such as a nickel-chromium alloy, copper or another metal. In general, the conduit 150 should be thermally conductive and resistant to thermal stress, mechanical stress and corrosion.

The leader 520 may be a fishing line, a flexible steel or stainless steel line or another material.

In some embodiments, the leader line 520 is lubricated to allow it to be easily inserted into and moved within the conduit 150. For example, the leader line 520 may be lubricated with graphite.

In other embodiments, the conduit 150 is internally lubricated while it is straight or generally straight. For example, a lubricant such as graphite is sprayed into or otherwise placed in the conduit 150 from one or both ends. The conduit 150 may be held upright to allow the lubricant to travel along the length of the conduit 150.

The leader line 520 is then pushed through the length of the conduit 150 so that it extends from both ends. In some embodiments, the leader line 520 is more than two times as long as the conduit 150. While the leader line 520 may be made of various materials, the inventors have found that a flexible metal leader line 520, such as a stainless steel leader line, is able to readily withstand the remaining steps of method 500 and operation of the furnace 100.

Method 500 then proceeds to step 504 in which the conduit 150, with the leader line 520 installed in it, is bent into the shape required for installation on the tapblock 120. In the present example embodiment, the conduit 150 is bent into the shape illustrated in FIGS. 3 and 4 to fit within the grooves 148 on tapblock 120.

Method 500 then proceeds to step 506 in which the shaped conduit 150 is installed on tapblock 120, as illustrated in FIG. 3. In this embodiment, the conduit 150 is press fit into the grooves 148 in the tapblock 120. The conduit 150 may also be held in place on the tapblock 120 by welding, adhesives, mechanical fasteners such as rivets, screws or wire retainers or any other means.

Method 500 then proceeds to step 508 in which the optic fibre 164 is installed in the conduit 150. One end of the optic fibre 164 is attached to leader line 520 adjacent either the first end 154 or the second end 156 of the conduit 150. Any method, including tape, adhesive or a mechanical coupling may attach the leader line 520 and the optic fibre 164. For example, the optic fibre 164 and the leader line 520 may be crimped together with a ferrule 524 pulled over both the leader line 150 and the optic fibre 164. The leader line 520 is then drawn through the conduit 150 from the opposite end of the conduit 150 until the optic fibre 164 is drawn through the conduit 150 and out of the opposite end. Note that the tapblock 120 is not illustrated in association with step 508 in FIG. 5.

Method 500 then proceeds to step 510, in which the optic fibre 164 is detached from the leader line 520, allowing it to slide freely within the conduit 150 independently of the leader line 520. The optic fibre 164 may be allowed to extend from the end of the conduit 150, or it may be cut so that it remains within the conduit 150. The leader line 520 may be removed from the conduit 150 or it may be left within the conduit 150 together with the optic fibre 164. If the leader line 520 is left in the conduit 150, it may be long enough that it extends from both the first end 154 and the second end 156 of the conduit 150 at all times, allowing it to be pulled back and forth to install another optic fibre in the conduit 150. For this purpose, the leader line 520 may be longer than two times the length of the conduit 150.

Method 500 then proceeds to step 512, in which the optic fibre 164 is coupled to the optical transceiver 162.

Method 500 then ends.

Method 500 is only an example of one method of installing the optic fibre 164 in the conduit 150. Many other methods are possible. For example, an optic fibre may simply be pushed through the length of the conduit 150, with or without a lubricant, depending on the ability of the optic fibre to withstand the mechanical stress of being pushed through the conduit 150. A leader line 520 may be pushed through a bent conduit 150 and then used to pull in the optic fibre 164. A leader line 520 may be blown through with compressed air. In some cases a first lightweight leader line may be blown through the conduit 150, and then used to pull through a heavier leader line, which is then used to pull in the optic fibre 164. Any such technique, and other techniques, may be used to install the optic fibre 164 in the conduit 150.

The optic fibre 164 may be installed in the tapblock 120 before or after the tapblock 120 is installed on a furnace 100. For example, the tapblock 120 may be installed on the furnace 100 between steps 506 and 508.

The shape of the conduit 150 is determined taking into account the characteristics of the optic fibre 164. For example, the optic fibre 164 will have a minimum bending radius beyond which its optical properties may be compromised. The optic fibre 164 may also have a maximum axial strain limit and other mechanical limitations. The shape and dimensions of the conduit 150 and the lubricant used in step 502 are selected such that the optic fibre 164 is not damaged during installation or operation of the furnace 100.

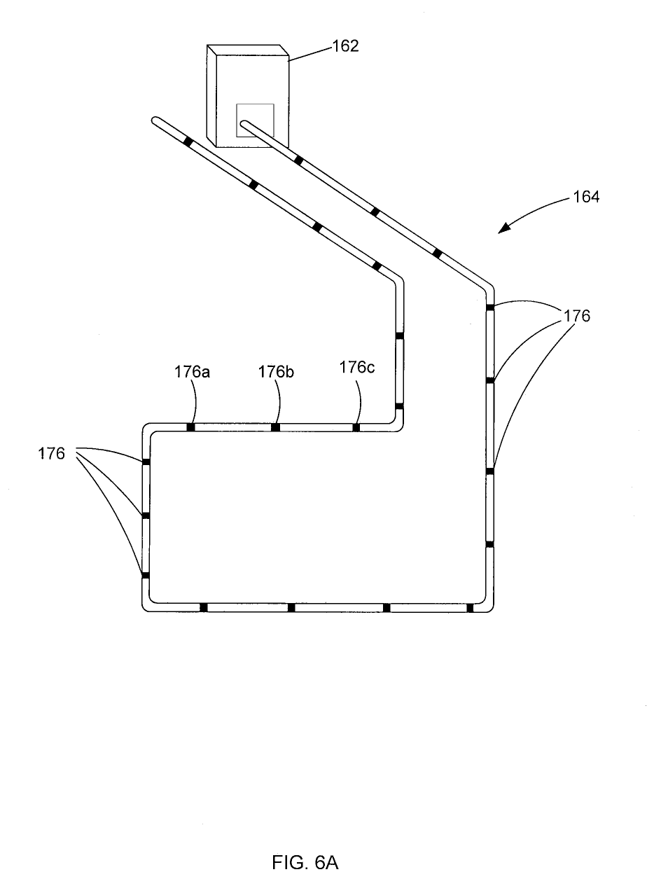

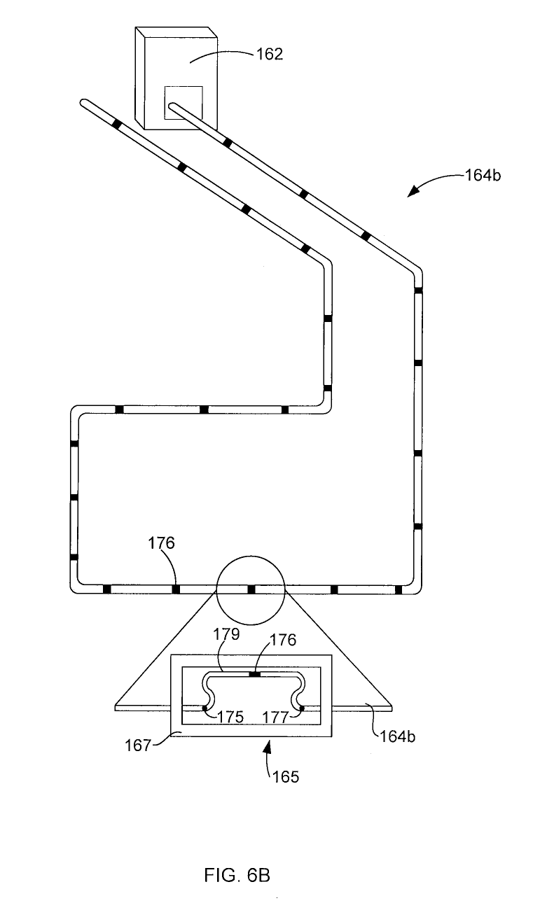

Reference is made to FIG. 6. Optic fibre 164 has a series of Bragg gratings 176 (which may also be referred to as fiber Bragg gratings or in-fiber Bragg gratings and other names) formed in it. Each Bragg grating 176 is formed by modifying the refractive index of the fibre core of the optic fibre 164. The modification creates a selective optical mirror that reflects radiation of a certain wavelength, called the Bragg wavelength 4. The Bragg wavelength of each Bragg grating 176 is determined by the structure of the Bragg grating 176. Techniques for forming such Bragg gratings 176 are known to skilled persons.

Optic fibre 164 is sensitive to temperature. As the temperature of a region of the optic fibre 164 changes, the region expands and contracts. The Bragg wavelength of a Bragg grating 176 in the region changes as the Bragg grating 176 expands and contracts. A temperature change in the region of the optic fibre 164 can be determined by comparing the Bragg wavelength of the optic fibre 164 at any time compared to the Bragg wavelength at a known temperature.

The Bragg wavelength of a region of an optic fibre 164 can also be affected by mechanical stress on the optic fibre 164. By allowing the free end of the optic fibre 164 at the second end 156 of the conduit 150 to slide within the conduit, mechanical stresses in the optic fibre 164 are reduced and any corresponding effect on the Bragg wavelength is also reduced.

In this embodiment, optic fibre 164 has a series of Bragg gratings 176 spaced about 10 cm apart. In other embodiments, the optic fibre 164 may have Bragg gratings 176 spaced closer or further apart. Bragg gratings 176 may be formed in the optic fibre 164 at specific locations such that the Bragg gratings 176 are positioned at specific points within or adjacent to the tapblock 120 during operation of the furnace 100.

Optic fibre 164 is a sensor cable that couples transceiver 162 to the Bragg gratings 176, which operate as thermal sensors. Each Bragg grating 176 is tuned to reflect a different range of wavelengths of radiation under expected temperature conditions during the operation of the furnace 100. In the present embodiment, the range of temperatures of interest may range from room temperature to over 200° C. IN other embodiments, application to higher temperatures is possible. The optic fibre 164 is chosen and the Bragg gratings 176 are formed to allow temperatures across the desired range to be sensed.

To determine the temperature at the position of each Bragg grating 176, the controller 160 operates the optical transceiver 162 to transmit radiation into the optic fibre 164 across the range of wavelengths corresponding to the Bragg grating 176. Some of the transmitted radiation is reflected back by the Bragg grating 176. The Bragg wavelength of the reflected radiation can be used to determine the temperature at the location of the Bragg grating 176. In some embodiments, this may be done by using a look-up table or formula that indicates the corresponding temperature for each reflected Bragg wavelength. In other embodiments, this may be done by comparing the reflected Bragg wavelength with a previously known Bragg wavelength for the same Bragg grating 176, at a corresponding known temperature, or by other methods.

Referring to FIG. 6B, in some embodiments, even when the end(s) of the optic fibre(s) 164 is/are free to move axially, one or more of the optic fibers 164 may be sensitive to strain. Accordingly, an alternate optic fibre 164b, which includes strain relief assembly 165, may optionally be used. Each strain relief assembly 165 includes a housing 167, in which a portion of the optic fibre 164b is received. The optic fibre 164b is secured to the housing 167 at two spaced apart locations 175, 177 within the housing 167. The portion 179 of the fiber 164b between locations 175, 177 has a length greater than the distance between the locations 175, 177, so that the portion 179 includes some slack, and strain in the portion 179 is reduced or prevented. A Bragg grating 176 is formed in this portion 179, reducing or preventing strain on the fiber 164b as a whole from affecting the operation of the Bragg grating 176. An optic fibre with a strain relief assembly may be used in a conduit or without a conduit in various embodiments.

Reference is next made to FIG. 3. The position of various Bragg gratings 176 within conduit 150 is illustrated at reference numerals 176. In essence, each Bragg grating 176 operates as an independent temperature sensor. Using an optic fibre 164 with integrated Bragg grating temperature sensors allows a relatively large number of sensors to be positioned within a tapblock 120. The temperature at each Bragg grating 176 may be independently determined by controller 160 during operation of the furnace 100. Various unacceptable temperature conditions may be defined based on the temperature at one or more Bragg gratings 176. If any unacceptable temperature condition occurs, controller 160 may be programmed to indicate the condition or to automatically trigger a change in the operation of the furnace 100, such as shutting down the furnace 100 or some other action.

Bragg gratings 176a-176c are positioned adjacent to the chamfer area 146 of the wall refractory 127 (FIG. 2), which, in many cases, exhibits more wear than other areas of the refractory 126 (FIG. 2). The inventors have found that monitoring the temperature on the hot face 132 (FIG. 2) of the tapblock adjacent to the chamfer area 146 of the wall refractory 127 (FIG. 2) provides a desirable early indication of excessive wear of the chamfer area refractory.

Reference is next made to FIG. 7, which illustrates cooling system 166. Water pump 168 pumps water through pipes 170 which are cast within the copper tapblock 120 along the length of tapping channel 122 and adjacent the hot face 132. Heat exchanger 169 removes heat from the water as it circulates. Heat from molten metal and slag penetrates through the wall refractory 127 (FIG. 2) and the tapping channel refractory 128 to the copper tapblock 120, where it is spread readily through the tapblock 120 due to the high thermal conductivity of copper. The water cooling system 166 removes heat from the tapblock 120, cooling both the copper tapblock 120 and the adjacent refractory 126. The cooling system 166 shown in FIG. 7 and other drawings is relatively simplified compared to a typical cooling system in a cooling element such as a tapblock 120. In some embodiments, the cooling system 166 may contain several pipes to cool the hot face 132 or the tapping channel 122.

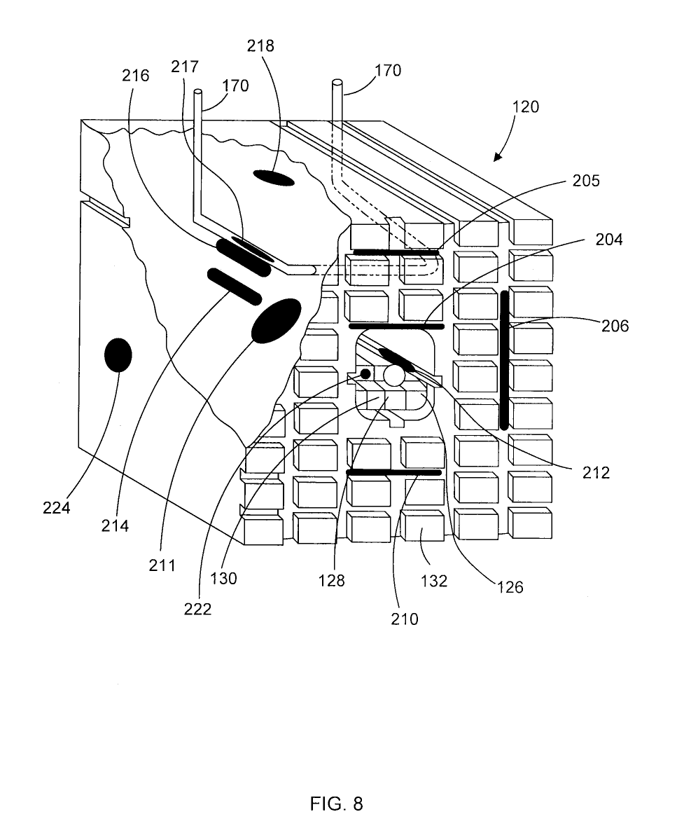

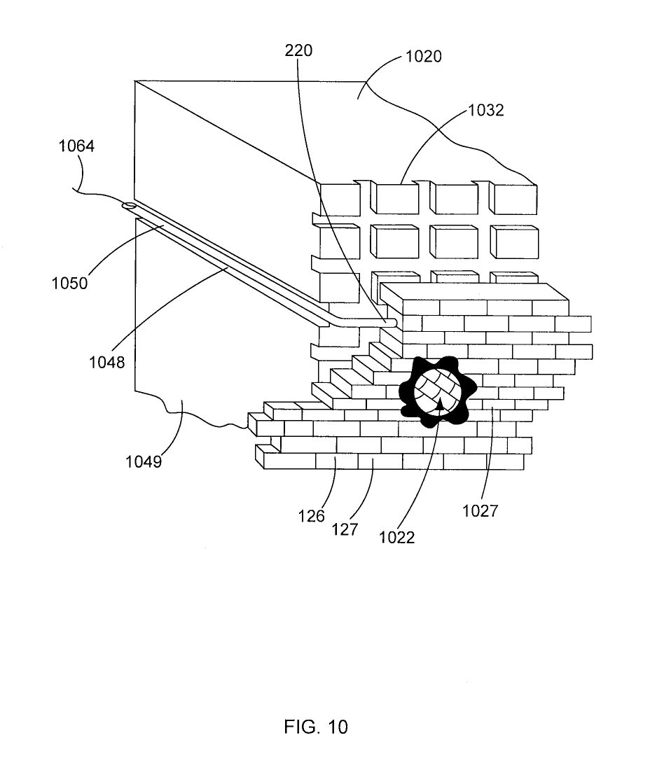

Referring to FIG. 8, thermal sensing system 172 (FIG. 4) may be used to monitor the temperature at numerous position or locations within, at the surface of and near the tapblock 120. Some of the locations at which the temperature may be monitored include:

| Reference numeral | Position |
|---|---|
| 204 | On hot face 132, adjacent chamfer area |
| | 146 |
| 205 | On hot face 132, above the chamfer area |
| | 146 |
| 206 | On hot face 132, spaced horizontally from |
| | tapping channel 122 |
| 210 | On hot face 132, below tapping channel |
| | 122 |
| 211 | Within tapblock 122 behind the hot face |
| | 132 |
| 212 | Along tapping channel 122 behind tapping |
| | channel refractory 128 |
| 214 | Within tapblock 120 between hot face 132 |
| | and cooling pipes 170 |
| 216 | Adjacent cooling pipes 170 |
| 217 | Within cooling pipes 170 |
| 218 | In tapblock 120 behind cooling pipes 170. |
| 220 (FIG. 10) | In the wall refractory 127 |
| 222 | In the tapping channel refractory 128 |
| 224 | On the side, top or bottom of the tapblock |
| | 120 |

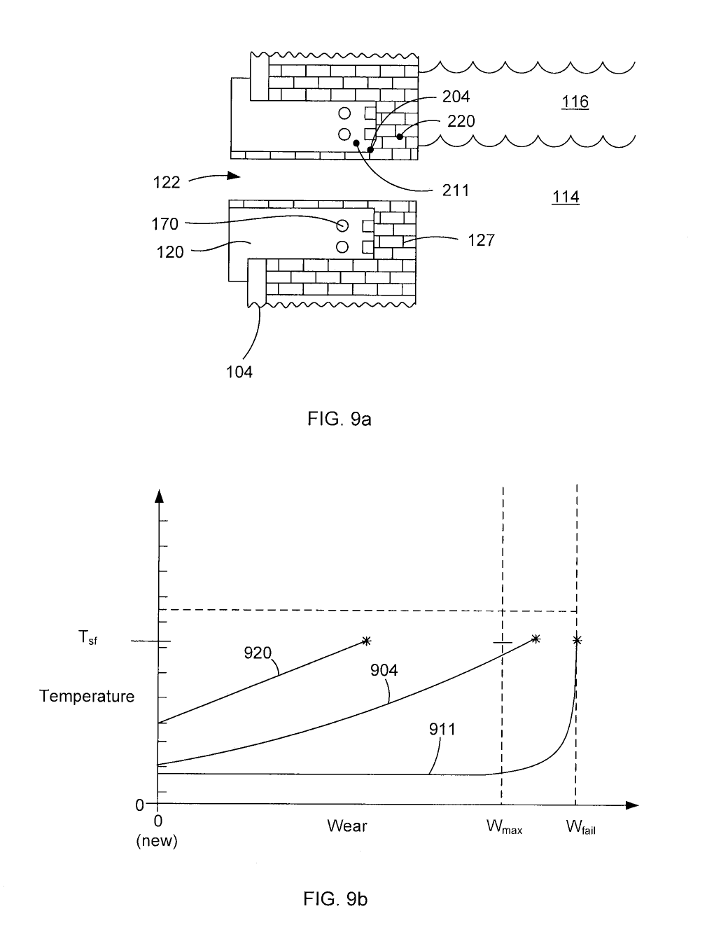

The illustrated positions in FIG. 9 are merely examples of the different regions of furnace 100 identified above. Each of these positions can yield useful temperature information.

Monitoring the temperature at position 204, which corresponds to Bragg gratings 176a-c (FIG. 3), allows the state of the wall refractory 127 in the chamfer area 146 to be assessed, as discussed above.

Position 205 is also at the hot face 132 adjacent the shell wall refractory 127. This position allows the wall refractory 127 above the chamfer area 146 to be monitored.

Like position 205, positions 206 and 210 are also at the hot face 132 adjacent the wall refractory 127. These positions allow the refractory near the tapping channel 122 to be monitored, while also providing protection for the optic fibre 164 and its protective conduit 150. As noted above, the maximum operating temperature of an optic fibre is typically limited and will generally be lower than the temperature of molten materials in the furnace 100. The refractory 127 protects the optic fibre 164 from the high heat of molten metal 114 and molten slag 116.

A Bragg grating in position 211 is separated further from molten materials than a Bragg grating in positions 204, 205, 206 and 210. In addition to the wall refractory 127, a Bragg grating in position 211 is also protected by the tapblock 120 itself. This may have the advantage that, in the event of a breakdown of the wall refractory 127 such that molten slag 116 comes into contact with the hot face 132, the optic fibre 164 will be protected. Due to the high thermal conductivity of copper, the entire water cooled tapblock 120 may be relatively cool. In some conditions, molten slag 116 will freeze on the hot face 132 of the tapblock 120 and can even form a protective layer where the wall refractory 127 has broken down. However, an optic fibre 164 at the hot face 132 may be damaged before the molten slag freezes. Embedding the optic fibre 164 within the tapblock 120 provides additional protection. The high thermal conductivity of copper will typically result in a lower temperature variation at position 211 compared to positions on the hot face 132. A Bragg grating at position 211 may be useful in various embodiments, including embodiments in which there is a high risk of the wall refractory 127 failing.

A Bragg grating at position 212 is at the face of the copper tapblock 120 adjacent the tapping channel refractory 128. An optic fiber 164 may be installed in grooves 149 to position gratings adjacent the tapping channel refractory 128. A Bragg grating in this position can be used to monitor the state of the tapping channel refractory 128 while being protected from molten materials in the tapping channel 122 by the tapping channel refractory 128. As with the other positions described here, position 212 is only illustrated in FIG. 9 by way of example. Any thermal sensor positioned at the surface of the tapblock 120 adjacent the tapping channel refractory 128 also in position 212. For example, a thermal sensor may be located between the tapblock 120 and the tapping channel refractory 128 along the top side of the tapping channel 122.

Bragg gratings in position 212 are positioned parallel to the tapping channel 122. The tapping channel refractory 128 can wear unevenly. For example, the tapping channel refractory 128 adjacent the cold face 134 can be damaged by lancing and other mechanical operations used to break the clay plug 136 in the tapping channel 122. Along the length of the tapping channel 122 the tapping channel refractory 128 may thin due to large temperature variations resulting from the periodic flow of molten metal and slag during tapping operations. Between tapping operations, the tapping channel 122 may be relatively cool even while the furnace 100 is operating.

Position 214 is similar to position 211. A Bragg grating in position 214 is embedded in the copper tapblock 120 and is protected from the flow of molten material through the tapping channel 122 by both the tapping channel refractory 128 and the tapblock 120 itself. Temperature variations within the tapblock 120 will typically be smaller than adjacent the refractory 126 and less sensitive to refractory condition.

Position 216 is adjacent the cooling pipes 170 within tapblock 120. A Bragg grating in this position may be used to measure changes in the temperature of cooling water as it travels through the cooling pipes 170 and may be useful to identify issues in the cooling system 166.

Position 217 is within the cooling pipes 170. A Bragg grating within the cooling pipes 170 may be useful to measure heat removal from the tapblock 120 to be measured, by comparing the temperature of the cooling water at various points along the length of the cooling pipes 170 or to the temperature of the cooling water when it is first pumped into the cooling pipes 170. An optic fibre 164 installed within the cooling pipes 170 may optionally be installed within a conduit to protect the optic fibre 164 from mechanical stresses associated with the movement of the water in the cooling pipes 170. Optionally, the conduit may be perforated to allow water to directly contact the optic fibre 164, thereby providing more accurate measurements of the water temperature at different locations.

A Bragg grating in position 218 is positioned further from the wall refractory 127 or the tapping channel refractory 128 than an intervening cooling pipe 170. A Bragg grating in position 218 may be useful to measure the total heat in the tapblock 120.

The present disclosure allows a number of thermal sensors to be positioned in one or more regions of a metallurgical reactor. If desired, thermal sensors may be densely positioned along the path of one or more sensor cables. For example, in some embodiments, a number of thermal sensors may be positioned on or adjacent to the hot face 132 to allow the condition of the wall refractory 127 to be monitored across the hot face 132.

Reference is next made to FIGS. 9a and 9b. FIG. 9a illustrates positions 204, 211 and 220 in a sectional drawing. FIG. 9b is a graph illustrating the sensed temperature at sensor positions 204, 211 and 220 as the wall refractory 127 wears. The horizontal axis shows the wear of the wall refractory 127 from new condition at the origin, to a maximum acceptable wear Wₘₐₓ in normal operation of the furnace 100 and to a level of wear W_{fail} at which the wall refractory 127 fails to protect the furnace 100, leading to failure of the furnace 100.

Line 920 reflects temperatures sensed at position 220 (FIG. 10). At this position, the temperature during furnace operation rises quickly as the wall refractory 127 wears. In the illustrated example, the sensor fails (at a point marked with an asterisk) before the wall refractory 127 wears to Wₘₐₓ. In other embodiments, the thermal sensor may be positioned within the wall refractory 127 closer to the hot face of the tapblock 120 such that it survives even after the wall refractory 127 has worn to Wₘₐₓ. Sensor position 220 is responsive to changes in refractory wear. The closer the thermal sensor is to the hot face of the wall refractory 127, the more responsive it will be to changes in refractory wear, and more likely it will be to be destroyed or fail early in the life of the refractory.

Line 904 reflects temperatures sensed at position 204 (FIG. 8), on the hot face 132 adjacent the chamfer area 146 (FIG. 2). Temperatures in this region are also sensitive to wall refractory wear, but less than the temperature at position 220. In the illustrated example, a sensor in position 204 may be operational until after the wall refractory 127 reaches Wₘₐₓ. The slope of line 904 is sufficient that changes in the temperature sensed at position 204 can be used to predict when the wall refractory 127 is approaching Wₘₐₓ.

Line 911 reflects temperatures sensed at position 211 (FIG. 8), which is within the tapblock 120. Within the tapblock 120 the sensed temperature may vary only slightly as the wall refractory 127 wears. Even as the wall refractory wear approaches Wₘₐₓ, the sensed temperature within tapblock 120 may not rise sufficiently to allow the wall refractory wear to be estimated. This may occur for a variety of reasons. For example, if the tapblock 120 is made of a metal with a high thermal conductivity, heat absorbed by the tapblock 120 may be readily dispersed through the tapblock 120, resulting in a lower temperature change at position 211. If the cooling system effectively cools the tapblock 120, then the temperature within the tapblock 120 may change little even as the wall refractory 127 wears significantly, particularly if the tapblock 120 is also made of highly thermally conductive material. In the example illustrated, the temperature sensed at position 211 rises significantly only after the wall refractory wear exceeds Wₘₐₓ and only shortly before the wall refractory 127 fails to protect the reactor at W_{fail}.

FIG. 9a only shows some examples of temperatures sensed at positions 204, 211 and 220. In various embodiments, the actual pattern of sensed temperatures will depend on the nature and position of the thermal sensors, the materials used in the furnace 100, and other factors.

Reference is made to FIG. 10, which illustrates a conduit 1050 extending into wall refractory 1027. Conduit 1050 is positioned in grooves 1048 formed in side surfaces 1049 of tapblock 1020. The conduit is spaced from the hot face 1032 and extends into the refractory 1027. An optic fibre 1064 extends from the end of the conduit 1050.

It is possible for the wall refractory 1027 to shift during use of a metallurgical furnace. In addition to the characteristics described above in relation to conduit 150 (FIG. 4) conduit 1050 is selected to be sufficiently flexible to withstand movement of the wall refractory relative to the sidewall 1004 and the tapblock 1020. Additionally, or alternatively, the conduit 1050 may be reinforced at the transition into and out of the wall refractory 1027, or may be covered at the transition point with a deformable material that will absorb the movement of the wall refractory 1027. In some embodiments, conduit 1050 may be made of different materials along its length. For example, the conduit 1050 may be made of copper in regions that are within the tapblock 1020 and may be made of a more resilient and more protective material at the transition to and within the wall refractory 1027. If a conduit material undesirably thermally insulates the optic fibre 1064 from the surrounding refractory, the conduit 1050 may be perforated, filled with a conductive material or otherwise modified to allow heat from the surrounding refractory to reach the optic fibre 1064 and Bragg gratings within it. In some embodiments, the conduit 1050 may have a gap along its length. In some embodiments, the conduit 1050 may be made of a flexible corrugated or braided material, such as braided stainless steel, providing a combination of flexibility and protection for the optic fibre 1064.

Referring to FIGS. 8 and 10, Bragg gratings in the refractory 126, such as in positions 220 or 222 may be used to quickly identify areas of the refractory 126 that are suffering severe long term wear or to identify areas that are rapidly breaking down or deteriorating due to a sudden change in the refractory 126. For example, rapid movement between refractory bricks could lead to a dangerous situation if not detected quickly. A Bragg grating positioned in the refractory 126 may be useful to identify such a breakdown or deterioration more quickly than a Bragg grating positioned on the hot face 132 of the tapblock 120 or on the copper surface of the tapblock 120 adjacent the tapping channel refractory 128. Referring briefly to FIG. 1, installing one or more thermal sensors in the bottom plate 106 or the hearth refractory 131 may also provide useful information. For example, a sensor in the bottom plate 106 or hearth refractory 131 may be useful to monitor the condition of the hearth refractory 131.

Referring again to FIG. 8, position 224 is illustrated on the surface of tapblock 120. The position includes the side, top and bottom surfaces of the tapblock 120. A thermal sensor positioned in these areas may be useful in identifying temperature changes resulting from a leak of molten material from inside furnace 100 through a gap between the tapblock 120 and the side plate 104 (FIG. 1) or adjacent a cooling element. Such a gap may form due to repetitive expansion and contraction of components of the furnace 100.

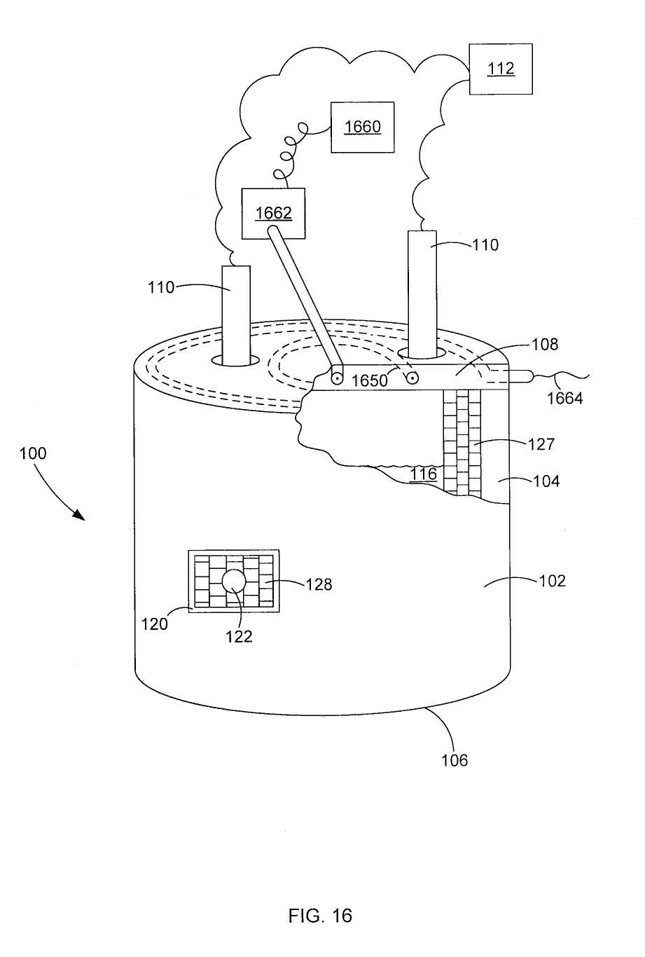

Reference is next made to FIG. 16, which illustrates a conduit 1650 extending into the roof 108 of the furnace 100. An optic fibre 1664 extends from the end of the conduit 1650. Thermal sensors in the roof 108 may be used to quickly identify areas of the roof 108 that are suffering severe long term wear or to identify areas that are rapidly breaking down or deteriorating. For example, the roof 108 may experience breakdown or deterioration due to exposure to hot gases in the freeboard region of the furnace 100 or due to radiated heat from the contents of the furnace 100.

In the embodiment shown, the conduit 1650 generally consists of multiple fibres that extend from the center to the periphery within the roof 108, so that the temperature may be measured at various positions in the roof 108. In alternate embodiments, the conduit 1650 may be of another suitable arrangement. For example, in some embodiments, one or more fibres may be installed in tubes extending radially within the roof. In some embodiments, tubes may be installed radially from the centre of the roof to the periphery, or diametrically across the roof. Fibres may be installed in the tubes to measure the temperature within the roof at various positions.

In the example shown, the roof 108 does not include refractory; however, in alternate embodiments, the roof may include refractory, which may be mounted to the interior surface of the roof, suspended from the roof or provided in another manner. Roof 108 is passively cooled by ambient air surrounding the furnace. In other embodiments, the roof may be actively cooled, for example, with cooling water running in tubes formed in the roof.

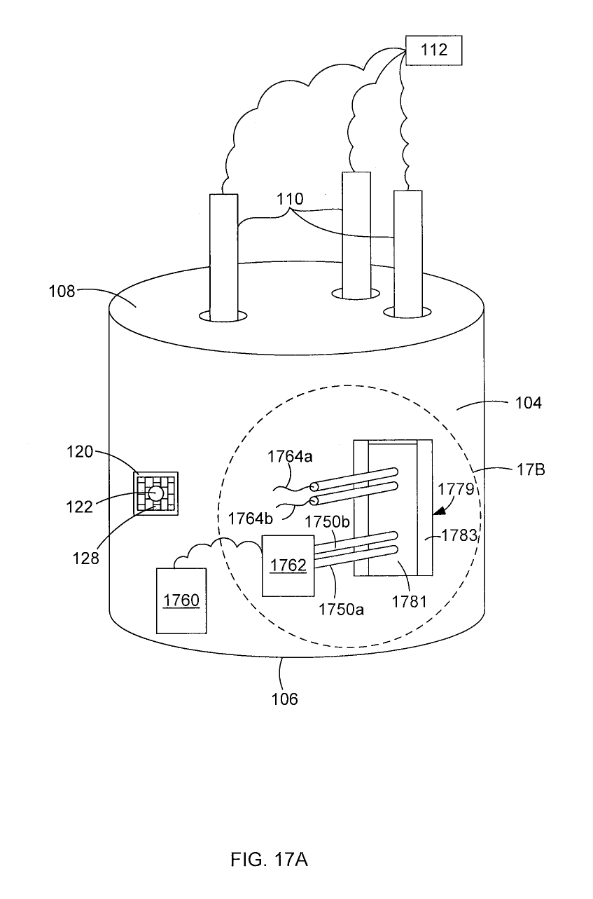

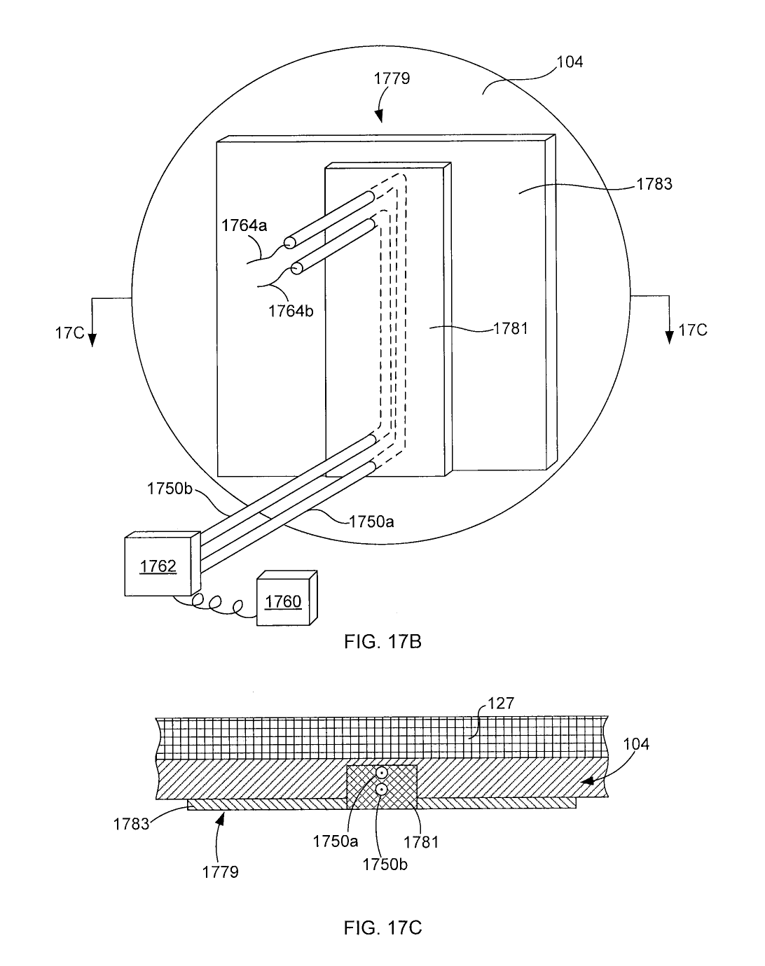

Thermal sensors positioned in other regions of the metallurgical furnace 100 may also provide useful temperature information. As described above, the metal side plate 104 (FIG. 1) of the furnace 100 is a cooling element of the furnace. Optionally, one or more thermal sensors mounted on the outer surface of the side plate 104 may be used to measure the amount of heat that is removed from the furnace 100 by the side plate 104. For example, with reference to FIGS. 17A to 17C, a sidewall monitoring unit 1779 is mounted to the furnace 100. The sidewall monitoring unit 1779 includes a block 1781 which is mounted to the side plate 104 by a mounting plate 1783, and is seated within a recess or aperture formed in the side plate 104. In some embodiments, the block 1781 may be formed of graphite. A first conduit 1750a and a second conduit 1750b are installed in the block 1781. Each conduit 1750 extends longitudinally thorough the block 1781. The first conduit 1750 is spaced relatively close to the wall refractory 127 for measuring the temperature adjacent to the wall refractory 127, and the second conduit 1750b is spaced relatively further away from the wall refractory 127 for measuring the temperature further away from the refractory. Optic fibres 1764a and 1764b extend through each conduit 1750a, 1750b, respectively, and include Bragg gratings as described hereinabove. A controller 1760 and an optical transceiver 1762 are coupled to the optic fibres 1764a, 1764b. This enables the temperature gradient and hence, heat flux, to be accurately measured.

It is possible to form Bragg gratings relatively close to one another along the length of an optic fibre, generally within a few centimeters of one another. In some embodiments, Bragg gratings may even be formed within a few millimeters of one another along some or all of the length of the optic fibre. By forming a plurality of Bragg gratings along the length of the optic fibre, it is possible to monitor the temperature at a large number of positions within the tapblock 120, refractory 126 or other parts of a furnace such as the roof or sidewall of the furnace.

In some embodiments, a plurality of optic fibres may be installed in or near the tapblock 120 such that Bragg gratings are positioned in various regions within, at the surface of and near the tapblock 120. In such embodiments, an optical transceiver may be shared between such optical fibres, or several optical transceivers may be provided to transmit radiation into the optical fibres and to sense the reflected Bragg wavelength emitted from the fibre.

The embodiments and variations described above utilize Bragg gratings formed in the optic fibre to reflect a Bragg wavelength. The Bragg wavelength is used to determine the temperature in the position or location of the Bragg gratings. In other embodiments, other techniques may be used to measure a temperature in a metallurgical furnace.

For example, an optic fibre may exhibit backscatter, a characteristic that results in radiation transmitted in the optic fibre being reflected from successive parts of the optic fibre. The reflected radiation may be analyzed using a backscatter reflectometer to assess various conditions along the length of the optic fibre, including temperature. In some embodiments, fibres without Bragg grating may be used together with a backscatter reflectometer or a similar device to analyze radiation reflected in the optic fibre to determine the temperature in a metallurgical furnace. In other embodiments, an optic fibre containing Bragg gratings may be coupled to a radiation sensor and controller that are configured to analyze both backscatter radiation and Bragg wavelengths from specific Bragg gratings to determine the temperature at positions along the length of the optic fibre. In such embodiments, the optic fibre is a sensor cable and also includes the thermal sensors themselves.

In other embodiments, the transceiver may be divided into a distinct radiation transmitter that transmits radiation into one end of an optic fibre and a distinct optical receiver coupled to the other end of the optic fibre to receive radiation that has been transmitted through the fibre. The transmitted radiation may be used to assess thermal conditions at positions along the length of the optic fibre.

In other embodiments, the sensor cable may be an electrical cable and thermal sensors may be resistive temperature devices, thermocouples or other elements that have a variable electrical characteristic in response to temperature. The thermal sensors may be installed in a metallurgical reactor together with the sensor cable, allowing one or more thermal sensors to be installed in a metallurgical furnace in an efficient manner, and without separately installing each thermal sensor and independently coupling each sensor to a controller. In various embodiments, a plurality of sensor cables may be used to monitor thermal conditions along a number of paths within the metallurgical furnace.

While a single sensor cable may be installed with a single thermal sensor, typically, the number of thermal sensors will exceed the number of sensor cables installed in an embodiment.

The embodiments described above include a conduit 150, 1050 or sheath that serves to protect the optic fibre 164, 1064, and also to facilitate installation of the optic fibre 164, 1064 in the furnace. In other embodiments, an optic fibre could be used without a conduit. An optic fibre could be positioned directly on a tapblock (and optionally other parts of the furnace) during assembly of the furnace.

In some embodiments, a conduit may be cast into a cooling element or another part of a reactor during manufacture. An optic fibre may subsequently be installed into the cast-in conduit.

The thermal sensing systems described above are merely examples of the use of the present invention in material processing assemblies such as metallurgical reactors.

Thermal sensing systems in which thermal sensors are mounted to or positioned within a sensor cable that is installed in an elevated temperature reactor may be used in a variety of ways and devices to monitor thermal conditions.

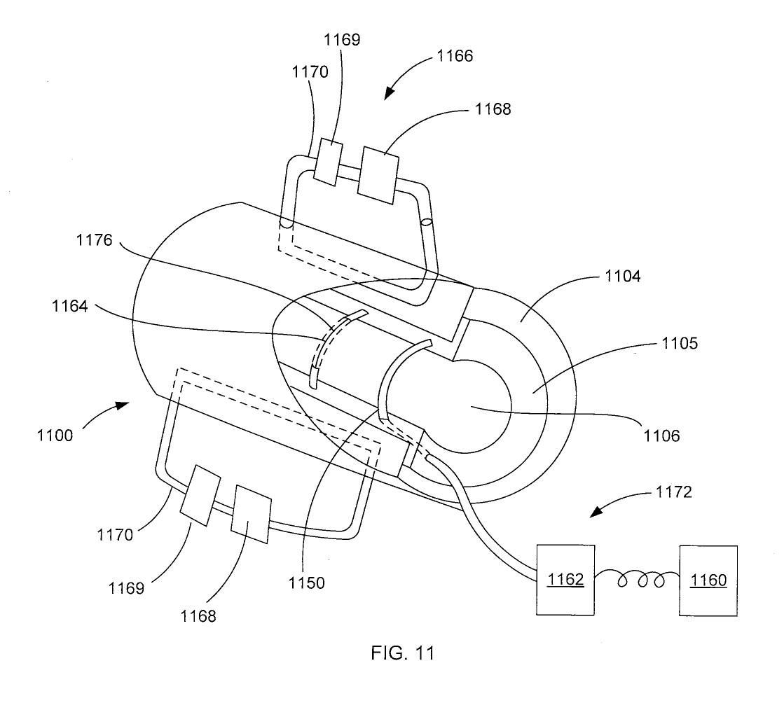

Reference is next made to FIG. 11, which illustrates a nozzle 1100 for a gasifier, which is another type of elevated temperature reactor. Nozzle 1100 has a metal nozzle body 1104 and a metal sleeve 1105 that lines a gas flow channel 1106. The nozzle body 1104 includes a cooling system 1166. Cooling system 1166 includes water pumps 1168, heat exchangers 1169 and water pipes 1170. Water pumps 1168 pump water through the water pipes to cool nozzle 1100. Heat exchangers 1169 remove heat from the water as it circulates. A thermal sensing system 1172 includes a controller 1160, a transceiver 1162, conduit 1150 and a sensor cable 1164. Sensor cable 1164 is installed within the conduit 1150. In this embodiment, the conduit 1150 may be installed in the sleeve 1105 in a spiral pattern, allowing a single sensor cable 1164 to be installed along the length of the sleeve 1105. In other embodiments, two or more sensor cables may be installed in the conduit 1150. Thermal sensors 1176 are coupled to or formed in the sensor cable 1164. As described above, the thermal sensors may be electrical, optical or other devices capable of sensing temperature. The sensor cable may be optical or electrical.

Thermal sensing system 1172 is used in a manner analogous to that described above in relation to system 172 (FIG. 4) to monitor thermal conditions in the sleeve 1105.

Sleeve 1105 is a thermal protective element that protects other components of nozzle 1100, including the nozzle body 1104, from gases passing through the gas flow channel 1106. In this embodiment, the sensor cable 1164 is mounted within the sleeve 1105. In other embodiments, the sensor cable 1164 may be positioned between the sleeve 1105 and the nozzle body 1104.

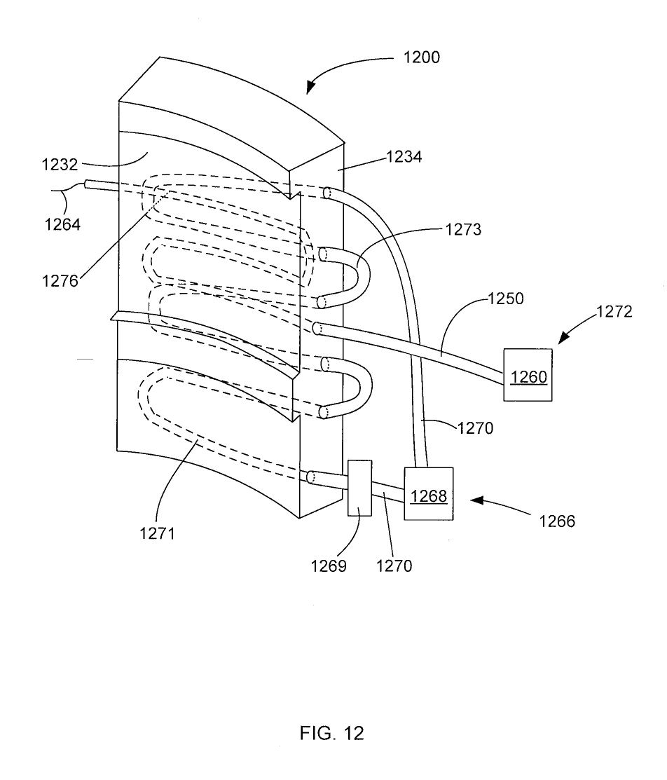

Reference is next made to FIG. 12, which illustrates a cooling block or stave 1200 that may be provided in an elevated temperature reactor such as a blast furnace. Stave 1200 has a hot face 1232 and a cold face 1234. Stave 1200 includes a cooling system 1266 that includes a water pump 1268, heat exchanger 1269 and water pipes 1270. Water pipes 1270 are coupled together to form a continuous fluid circuit, as shown at 1271 and 1273. A thermal sensing system 1272 includes a controller 1260, a sensor cable 1264, an optional conduit 1250 and thermal sensors, which are mounted to the sensor cable within the conduit. Sensor cable 1264 is coupled to controller 1260, as may be appropriate for the sensor cable 1264. Thermal sensors 1276 (hidden within stave 1202 in FIG. 12) are mounted to sensor cable 1264 along its length, allowing controller 1260 to obtain temperature data from each of the thermal sensors.

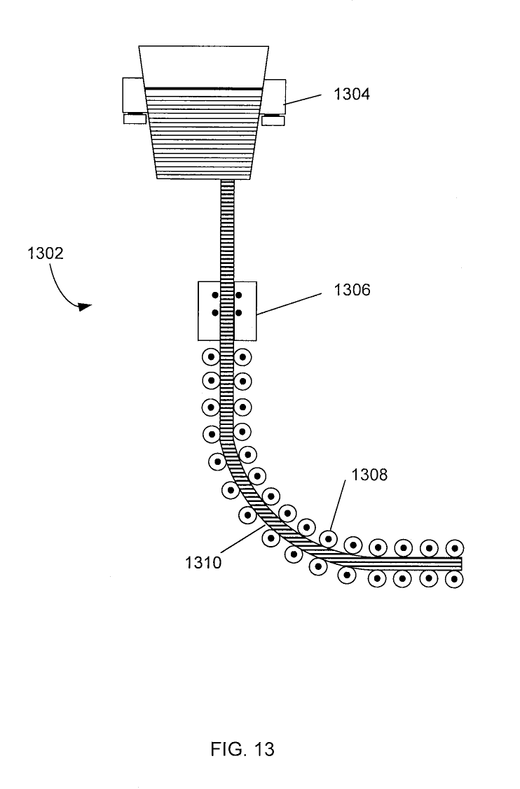

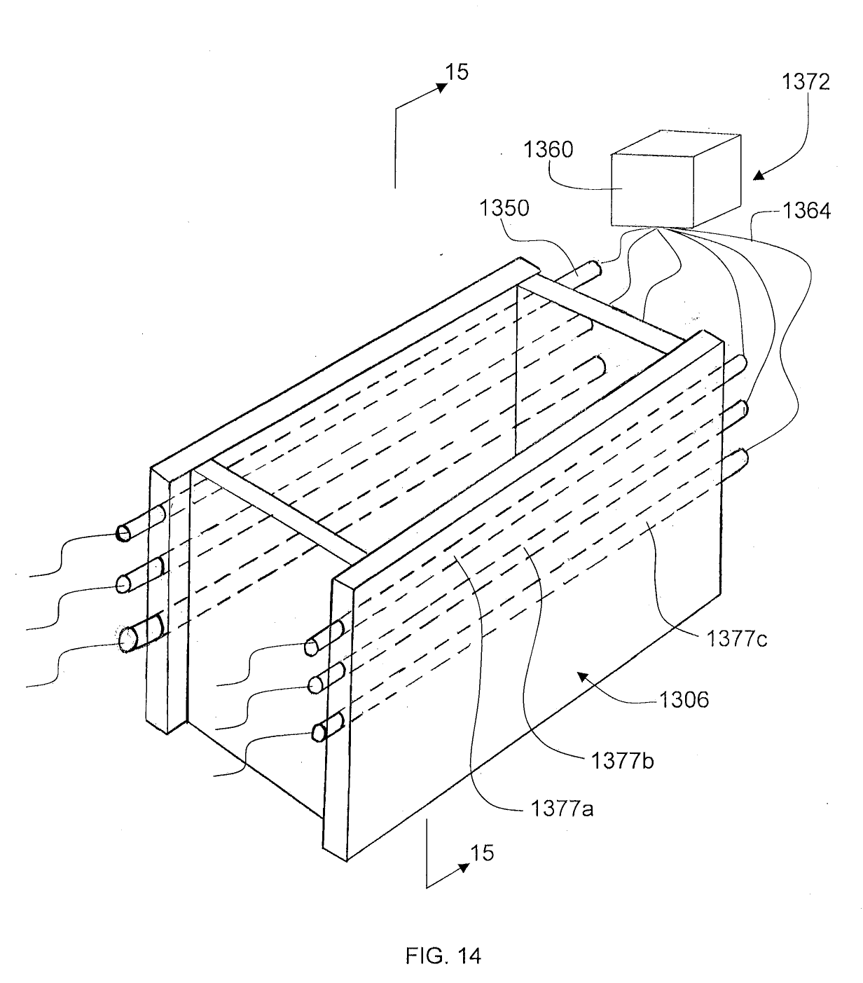

Reference is next made to FIG. 13, which illustrates a continuous casting assembly 1302, which is another example of a material processing assembly, and particularly, of a metal forming assembly. The continuous casing assembly 1302 includes a ladle 1304, which holds molten metal. Molten metal passes from the ladle 1304 into a mould 1306 (shown in more detail in FIG. 14), which is cooled by a cooling system (not shown). The cooling system may include a water pump, heat exchanger and water pipes. The water pipes or channels may be embedded within some or all of the walls of the mould, or the water pipes may surround the mould. The molten metal is cooled and begins to solidify in the mould 1306, and passes out of the mould between a series of rollers 1308, in the form of a slab 1310.

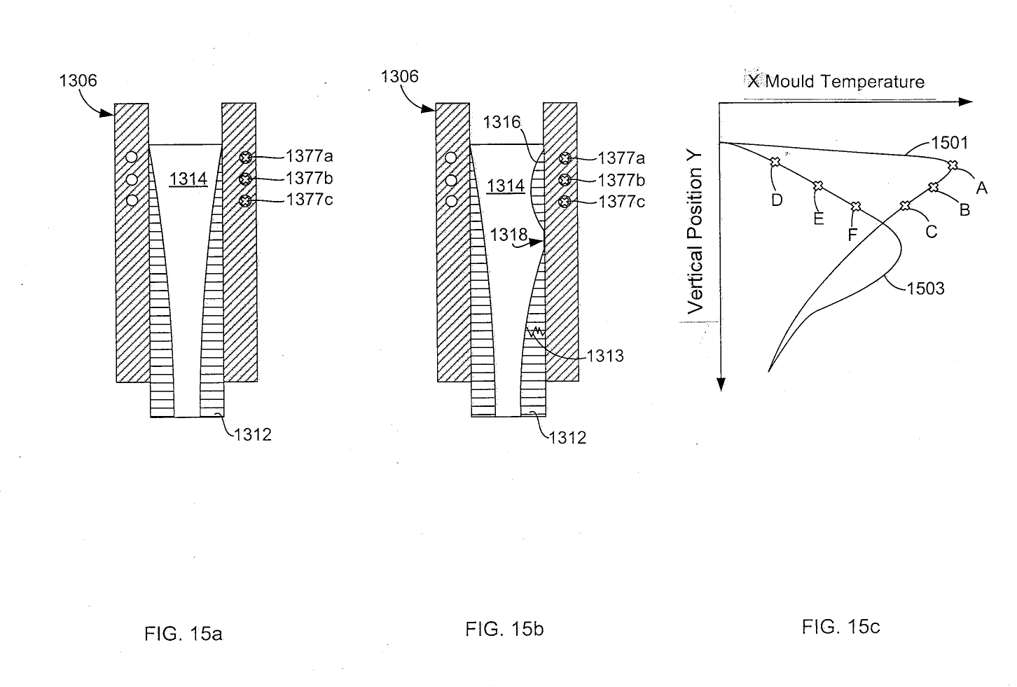

With reference to FIG. 15a, in normal operation of the continuous casting assembly 1302, the cooling of the mould causes a shell 1312 of metal to solidify in the mould 1306. The shell of metal surrounds a molten metal core 1314. The shell 1312 and core 1314 pass out of the mould 1306 together, between the rollers 1308, where the metal core 1314 solidifies.

With reference to FIG. 15b, a problem that may occur during continuous casing is mould breakout. This occurs when the molten metal of the core 1314 spills out of the mould 1306. Mould breakout may occur if solidifying metal sticks to the mould (shown at 1316), causing a tear 1318 in the shell 1312 of solidified metal. Cracking of the shell 1312, exemplified by crack 1313, is another cause of mould breakout.

With reference again to FIG. 14, a thermal sensing system 1372 is mounted to the mould 1306, for monitoring the temperature at various points within the mould 1306. As will be described further below, the thermal sensing system 1372 may be used to detect if solidifying metal is stuck to the mould 1306, or to detect cracks or other problems, and may thereby be used to predict mould breakout. Temperature feedback can also be used to control process parameters, production rate, and product quality. The thermal sensing system 1372 includes a controller 1360, a sensor cable 1364, an optional conduit 1350, and thermal sensors (not shown), which are written onto the fibres of the sensor cable 1364 within the conduit 1350. Sensor cable 1364 is coupled to controller 1360, as may be appropriate for the sensor cable 1364. Thermal sensors are positioned on the sensor cable 1364 along its length, allowing controller 1360 to obtain temperature data from each of the thermal sensors. The thermal sensors may be positioned anywhere along the length of the sensor cable 1364. In the example shown, the thermal sensors are both along the length of the mould (i.e. in a direction parallel to the flow of metal), as well as around the perimeter of the mould. Three exemplary locations for thermal sensors are shown by reference numerals 1377a, 1377b, and 1377c. As described above, the thermal sensors may be electrical, optical or other devices capable of sensing temperature. The sensor cable 1364 may be optical or electrical. The thermal sensing system 1372 is used in a manner analogous to that described above in relation to system 172 (FIG. 4) to monitor thermal conditions in the mould 1306.

As mentioned above, the thermal sensing system 1372 may be used to detect whether solidifying metal is stuck to the mould 1306, and to detect cracks and other problems, and may thereby be used to predict mould breakout or other mould conditions of interest. The thermal sensing system 1372 may also be used to control product quality and production rates. With reference to FIG. 15c, temperature profiles 1501 and 1503 are shown for normal operation of the continuous casting assembly 1302, and when solidifying metal sticks to the mould 1306 of the continuous casting assembly 1302, respectively. In FIG. 15c, temperature is represented along the X-axis, and the length of the mould, from the top of the mould to the bottom of the mould, is represented along the Y-axis. Points A, B, and C represent temperatures measured at locations 1376a, 1376b, and 1376c, respectively, during normal operation of the continuous casting assembly 1302. Points D, E and F represent temperatures measured at locations 1376a, 1376b, and 1376c, respectively, when solidifying metal sticks to the mould 1306 of the continuous casting assembly 1302. As shown in FIG. 15c, temperature profile 1503 is different from temperature profile 1501. The temperature inversion is indicative of a problem in the mould. Accordingly, by monitoring the temperature at various points within the mould 1306 with the sensing system 1372, it is possible to detect whether solidifying metal is stuck to the mould 1306, and thereby predict mould breakout. If the temperature profile 1503 occurs, steps may optionally be taken to prevent or minimize the risk of mould breakout. For example, casting speed may be reduced.

In alternate embodiments, the thermal sensing system 1372 may be mounted to another component of the continuous casting assembly 1302 that is subjected to elevated temperatures, such as to the ladle 1304, or the rollers 1308.

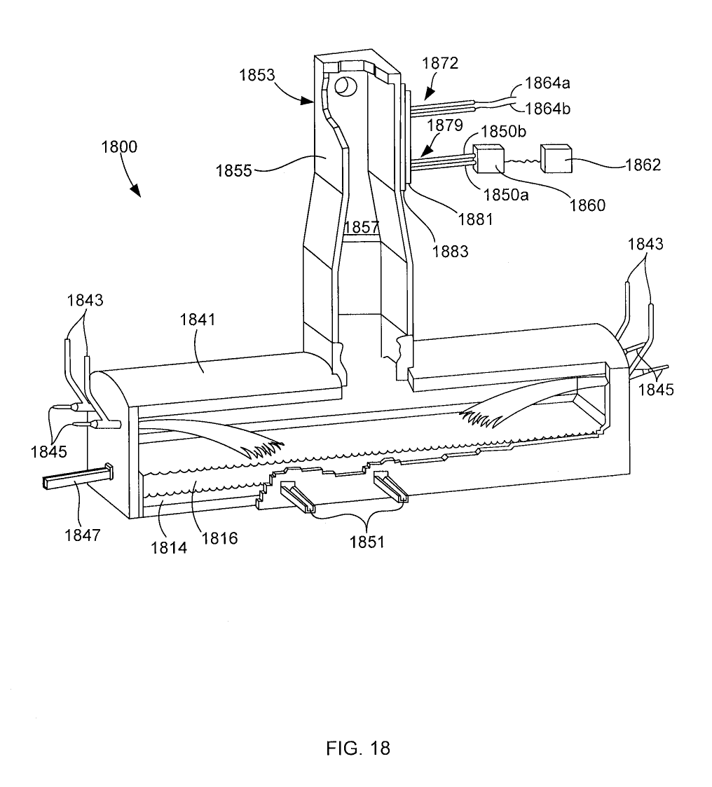

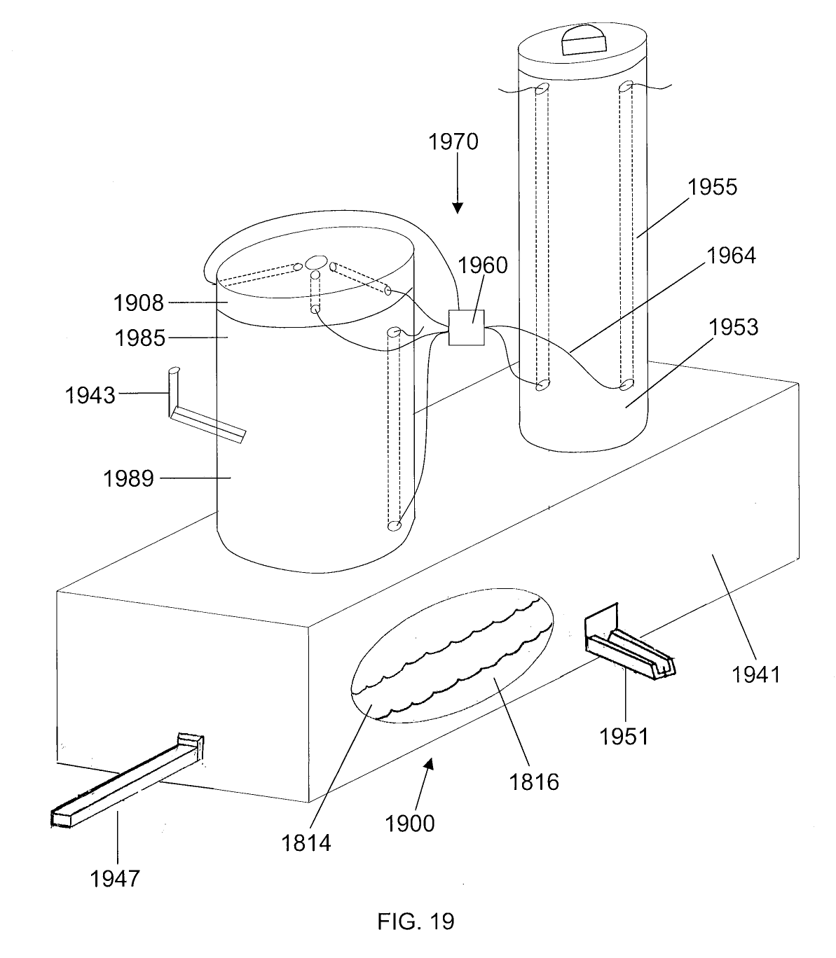

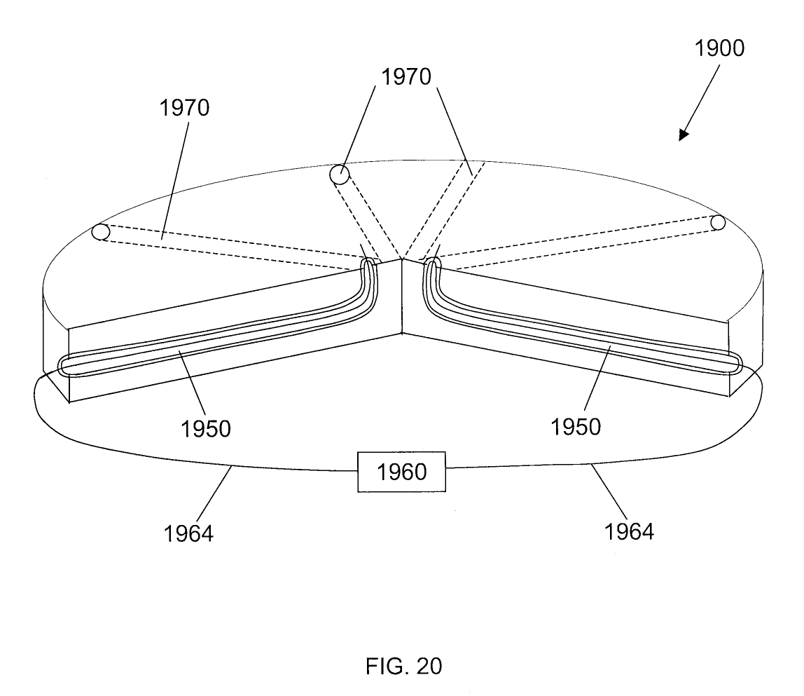

Reference is next made to FIG. 18, which illustrates a flash furnace or gas combustion chamber 1800, which is another type of metallurgical reactor. The flash furnace 1800 includes a furnace body 1841 having dry feed inlets 1843 and gas inlets 1845. The dry feed may be, for example, a copper concentrate CuFeS₂, including flux, SiO₂, and the gas may be, for example, oxygen. The dry feed and the gas combust as they are fed into the body 1841 of the flash furnace 1800, to produce a liquid matte layer 1814, a slag layer 1816, and an off-gas. The matte layer 1814 may include, for example Cu₂S and FeS, and the off-gas may include, for example SO₂. The body 1841 of the flash furnace 1800 further includes a slag outlet 1847 for removing the slag from the furnace, and matte outlets 1851 for removing the matte from the furnace 1800. An off-gas chimney 1853 extends from the body 1841 of the furnace, for removing the off-gas from the furnace 1800. The off gas chimney 1853 includes an outer wall 1855 and an interior 1857.

High temperatures may occur at various locations in the flash furnace 1800, and a thermal sensing system may be mounted to the flash furnace 1800 for monitoring the temperature at various locations. For example, referring still to FIG. 18, a thermal sensing system 1872 is mounted to the off-gas chimney 1853 to measure the temperature at various locations in the outer wall 1855 of the off-gas chimney 1853. In the example shown, the thermal sensing system 1872 is configured similarly to the thermal sensing system 1772 of FIGS. 17A to 17C. Particularly, the thermal sensing system 1882 includes a monitoring unit 1879 mounted to the outer wall 1855 of the off-gas chimney 1853. The monitoring unit 1879 includes a block 1881 that is mounted to the outer wall 1855 by a mounting plate 1883, and which is seated within a recess of the outer wall 1853. In alternate embodiments, the monitoring unit may be mounted to any portion of the outer wall or may be positioned in an aperture in the outer wall.

A first conduit 1850a and a second conduit 1850b are installed in the block 1881. Each conduit 1850 extends longitudinally thorough the block 1881. The first conduit 1850 is spaced towards and adjacent to the interior 1857 of the off-gas chimney 1853 for measuring the temperature in the outer wall 1855 adjacent to the interior 1857, and the second conduit 1850b is spaced away from the interior 1857 for measuring the temperature in the outer wall 1855 further away from the interior 1857. Optic fibres 1864a and 1864b extend through each conduit 1850a, 1850b, respectively, and include

Bragg gratings as described hereinabove. A controller 1860, an optical transceiver 1862 are coupled to the optic fibres 1864a, 1864b.

In other embodiments the temperature optic fibres may be positioned in conduits formed or installed in wall of the chimney.

Reference is next made to FIG. 19, which illustrates a flash smelting furnace 1900. Furnace 1900 has a body 1941, a reaction shaft 1985 and a chimney or off-gas shaft 1953. A roof 1908 is installed on the reaction shaft 1985. Feed is added to the reaction shaft 1985 through feed inlets 1943 into a concentrate burner (not shown). As the feed is smelted, matte 1914 and slag collect in the furnace body 1941. The matte and slag may be removed from the body through slag outlet 1947 and matte outlets 1951. Off-gases and some other by-products of the smelting operation are exhausted through chimney 1953. Furnace 1900 includes a thermal sensing system 1972 that monitors temperatures in roof 1908, the wall 1989 of the reaction shaft 1985 and the wall 1955 of the chimney 1953. Thermal sensing system 1972 includes a controller 1960 and various sensor cables, optional conduits and thermal sensors as described below.

Conduits 1970 are installed in the walls 1989 and 1955. Sensor cables 1964 are installed in the conduits 1970 and are also coupled to controller 1960.

Referring to FIG. 20, the roof 1908 is illustrated in greater detail. Roof 1908 includes radially extending cooling pipes 1970 through which a cooling fluid such as chilled water is pumped by a pump (not shown). Conduits 1950 are installed radially within the roof 1908. Sensor cables 1964 are installed in the conduits 1950 and coupled to the controller 1960. Thermal sensors are mounted to or formed in sensor cables 1964 along its length, allowing controller 1960 to obtain temperature data from each of the thermal sensors, as described above.

Referring again to FIG. 19, controller 1960 operates the thermal sensing system 1972 as described above to monitor temperatures in the roof 1908 and wall 1989 of the reaction shaft 1985 and in the wall 1955 of the chimney 1953.

Various embodiments of the present invention have been described here by way of example only. The illustrated embodiments may be modified to monitor thermal conditions in a wide variety of material processing assemblies and such embodiments fall within the scope of the invention, which is limited only by the following claims.

1.-57. (canceled)

58. A system for sensing thermal conditions in a material processing assembly, the system comprising:
a component that is subjected to elevated temperatures a sensor cable mounted to the component;
two or more thermal sensors positioned along the length of the sensor cable; and
a controller coupled to the sensor cable to receive information from the thermal sensors.

59. The system of claim 58, wherein the material processing assembly is an elevated temperature reactor, and the component is a cooling element of the reactor.

60. The system of claim 58, wherein the reactor comprises a roof and wherein at least some of the thermal sensors are positioned to monitor the temperature of the roof.

61. The system of claim 59, wherein the elevated temperature reactor is a metallurgical furnace, and the component is a tapblock.

62. The system of claim 58, wherein the material processing assembly is an elevated temperature reactor, and the component is a thermally protective element of the reactor.

63. The system of claim 58, wherein the material processing assembly is a glass furnace, and the component is a cooling element of the glass furnace.

64. The system of claim 58, wherein the material processing assembly is an induction furnace, and the component is a cooling element of the induction furnace.

65. The system of claim 58, wherein the material processing assembly is a metal forming assembly, and the component is a cooling element.

66. The system of claim 65, wherein the material processing assembly is a continuous casting assembly, and the component is a cooled mould.

67. The system of claim 58, wherein the component is cooling element.

68. The system of claim 58, wherein the component is subject to at least one of breakdown and deterioration.

69. The system of claim 58, wherein the component is adjacent to an element that is subject to breakdown.

70. The system of claim 58, wherein the sensor cable is mounted to the component in a path, and wherein the thermal sensors are positioned along the path at selected locations.

71. The system of claim 58, wherein the thermal sensors are resistive temperature devices and the sensor cable electrically couples the thermal sensors to the controller to allow the controller to communicate with the sensors.

72. The system of claim 58, wherein the thermal sensors are thermocouples and the sensor cable electrically couples the thermal sensors to the controller to allow the controller to communicate with the sensors.

73. The system of claim 58, wherein the sensor cable is an optic fibre and the thermal sensors are Bragg gratings formed in the optic fibre.

74. The system of claim 58, wherein the sensor cable is an optic fibre and the thermal sensors provide electrical signals and wherein each thermal sensor is coupled to the sensor cable through a transducer.

75. A system for sensing thermal conditions in a materials processing assembly, the system comprising:
an optic fibre having a first end and a second end;
a radiation source coupled to the first end of the optic fibre for transmitting radiation into the optic fibre;
a radiation sensor for sensing radiation reflected from within the optic fibre;
a controller coupled to the radiation sensor to sense radiation reflected from within the optic fibre and configured to measure a temperature at a position within the material processing assembly based on the sensed radiation.

76. The system of claim 75, further including a tapblock, wherein the optic fibre is mounted to the tapblock.

77. The system of claim 75, further including a conduit mounted to the tapblock, wherein the optic fibre is positioned within the conduit, and wherein the second end of the optic fibre is able to slide within the conduit.

78. The system of claim 75, wherein the optic fibre includes one or more Bragg gratings, wherein the radiation sensor is configured to detect a Bragg wavelength of radiation reflected from one of the Bragg gratings and wherein the controller is configured to measure the temperature in the reactor in the region where the Bragg grating is located.

79. The system of claim 75, wherein the optic fibre includes a plurality of Bragg gratings spaced along the length of the optic fibre, wherein each of the Bragg gratings is tuned to reflect a different range of wavelengths in response to different temperature conditions, and wherein the controller is configured to measure the temperature at the position of a particular Bragg grating by controlling the radiation source to transmit radiation corresponding the particular Bragg grating and in response to a Bragg wavelength sensed by the radiation sensor.

80. The system of claim 75, further including an output device coupled to the controller to present the measured temperature to an operator.

81. The system of claim 75, further including one or more strain relief assemblies for reducing strain on one or more corresponding portions of the optic fibre and wherein one or more of the Bragg gratings is formed in the corresponding portions of the optic fibre.
